(19) United States
(12) Patent Application Publication
(10) Pub. No.: US 2026/0061366 A1
(43) Pub. Date: Mar. 5, 2026

(54) SYSTEMS AND METHODS FOR TREATMENT OF VENTILATION AIR METHANE

(71) Applicant: Archaea Energy Inc:, Houston, TX (US)

(72) Inventors: Mark Erickson, Houston, TX (US); James Smith, Conroe, TX (US); Zachary Payne, Katy, TX (US); Cary Allen, Cypress, TX (US)

(73) Assignee: Archaea Energy Inc:, Houston, TX (US)

(21) Appl. No.: 19/312,132

(22) Filed: Aug. 27, 2025

Related U.S. Application Data
(60) Provisional application No. 63/688,644, filed on Aug. 29, 2024.

(51) Int. Cl. B01D 53/75; B01D 53/34; B01D 53/72; B01D 53/86

(52) U.S. Cl. CPC B01D 53/75; B01D 53/343; B01D 53/72; B01D 53/864; B01D 53/869; B01D 2257/7025; B01D 2258/06

(57) ABSTRACT

A process for air purification includes feeding a first stream comprising methane into a regenerative thermal oxidizer (RTO). The RTO is configured to thermally oxidize a first portion of the methane within the first stream. The process also includes obtaining a thermally oxidized first stream from the RTO. The thermally oxidized first stream comprises a second portion of the methane, and the second portion of the methane is not thermally oxidized within the RTO. In addition, the process includes feeding the thermally oxidized first stream into a catalytic reactor configured to catalytically oxidize the second portion of methane within the thermally oxidized first stream. The catalytic reactor comprises a methane catalyst. Further, the process includes obtaining a methane lean stream from the catalytic reactor.

### CROSS-REFERENCE TO RELATED APPLICATIONS

This application claims benefit of U.S. provisional patent application Ser. No. 63/688,644 filed Aug. 29, 2024, and entitled “Systems and Methods for Treatment of Ventilation Air Methane,” which is hereby incorporated by reference in its entirety for all purposes.

### STATEMENT REGARDING FEDERALLY SPONSORED RESEARCH OR DEVELOPMENT

Not applicable.

### TECHNICAL FIELD

The disclosure relates generally to the treatment of an air stream including pollutant molecules. More particularly, the disclosure relates to systems and methods for reducing fugitive emissions of methane from mine ventilation air.

### BACKGROUND

Significant amounts of adsorbed methane in coal deposits may be released during a mining process due to the chemical nature of subterranean coal. Because of methane's liberation (e.g., release) from coal deposits and the relatively small concentration of methane required to reach its flammable limit, subterranean coal mines may employ ventilation air methane (“VAM”) systems to circulate the vast quantities of air to prevent undesirable conditions from forming below the surface. Traditional systems may utilize Regenerative Thermal Oxidizers (“RTOs”) to destroy methane and other volatile gases within the pollutant air stream with enhanced energy conservation. Unfortunately, a portion of the pollutant air stream bypasses the thermal oxidation due to a transition period of the RTO. Furthermore, the high energy inputs to reach the desirable operating temperatures of RTO systems represent significant operating costs. Further, as regulations related to the environment, and specifically methane emissions, increase, traditional RTO systems may not meet the regulations.

### SUMMARY

Embodiments of processes for air purification are disclosed herein. In an embodiment, a process for air purification comprises feeding a first stream comprising methane into a regenerative thermal oxidizer (RTO). The RTO is configured to thermally oxidize a first portion of the methane within the first stream. The process also comprises obtaining a thermally oxidized first stream from the RTO. The thermally oxidized first stream comprises a second portion of the methane, and the second portion of the methane is not thermally oxidized within the RTO. In addition, the process comprises feeding the thermally oxidized first stream into a catalytic reactor configured to catalytically oxidize the second portion of methane within the thermally oxidized first stream. The catalytic reactor comprises a methane catalyst. Further, the process comprises obtaining a methane lean stream from the catalytic reactor.

In another embodiment, a process for air purification comprises directing a portion of a first stream into a first heat exchanger. The portion of the first stream is a second stream and the first heat exchanger is configured to place the second stream in a heat exchange relationship with a second portion of a methane lean stream. The process also comprises feeding the second stream into a first catalytic reactor configured to catalytically oxidize a first portion of methane within the second stream. The first catalytic reactor comprises a methane catalyst. In addition, the process comprises obtaining a catalytically oxidized second stream from the first catalytic reactor. The catalytically oxidized second stream comprises a second portion of methane within the second stream, and the second portion of methane within the second stream is not catalytically oxidized within the first catalytic reactor. Further, the process comprises feeding the first stream into a regenerative thermal oxidizer (RTO). The RTO is configured to thermally oxidize a first portion of the methane within the first stream. Still further, the process comprises obtaining a thermally oxidized first stream from the RTO. The thermally oxidized first stream comprises a second portion of methane within the first stream, and the second portion of methane within the first stream is not thermally oxidized. Moreover, the process comprises feeding the thermally oxidized first stream into a second heat exchanger configured to place the thermally oxidized first stream into a heat exchange relationship with a first portion of the methane lean stream. The process also comprises combining the thermally oxidized first stream with the catalytically oxidized second stream upstream of a second catalytic reactor, relative to a flow of the thermally oxidized first stream. The thermally oxidized first stream and the catalytically oxidized second stream at least partially define a combined stream. In addition, the process comprises feeding the combined stream into the second catalytic reactor configured to catalytically oxidize the second portion of methane within the first stream and the second portion of methane within the second stream. The second catalytic reactor comprises a methane catalyst. Further, the process comprises obtaining the methane lean stream from the second catalytic reactor. Still further, the process comprises partitioning the methane lean stream into the first portion of the methane lean stream and the second portion of the methane lean stream. Moreover, the process comprises recycling the first portion of the methane lean stream into the second heat exchanger. The process also comprises recycling the second portion of the methane lean stream into the first heat exchanger.

Embodiments of systems for air purification are disclosed herein. In an embodiment, a system for air purification comprises a regenerative thermal oxidizer (RTO) configured to thermally oxidize a first portion of methane within a first stream to create a thermally oxidized first stream. The system also comprises a catalytic reactor configured to catalytically oxidize a second portion of the methane within the first stream to create a methane lean stream. The catalytic reactor comprises a methane catalyst.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic diagram of an embodiment of a Ventilation Air Methane (“VAM”) mitigation system, in accordance with an aspect of the present disclosure;

FIG. 2 is a process diagram related to the embodiment of the VAM mitigation system of FIG. 1, in accordance with an aspect of the present disclosure;

FIG. 3 is a schematic diagram of an embodiment of a VAM mitigation system, in accordance with an aspect of the present disclosure;

FIG. 4 is a process diagram related to the embodiment of the VAM mitigation system of FIG. 3, in accordance with an aspect of the present disclosure;

FIG. 5 is a schematic diagram of an embodiment of a VAM mitigation system, in accordance with an aspect of the present disclosure;

FIG. 6 is a process diagram related to the embodiment of the VAM mitigation system of FIG. 5, in accordance with an aspect of the present disclosure;

FIG. 7 is a schematic diagram of an embodiment of a VAM mitigation system, in accordance with an aspect of the present disclosure;

FIG. 8 is a process diagram related to the embodiment of the VAM mitigation system of FIG. 7, in accordance with an aspect of the present disclosure;

FIG. 9 is a schematic diagram of an embodiment of a VAM mitigation system, in accordance with an aspect of the present disclosure;

FIG. 10 is a process diagram related to the embodiment of the VAM mitigation system of FIG. 9, in accordance with an aspect of the present disclosure;

FIG. 11 is a schematic diagram of an embodiment of a VAM mitigation system, in accordance with an aspect of the present disclosure; and

FIG. 12 is a process diagram related to the embodiment of the VAM mitigation system of FIG. 11, in accordance with an aspect of the present disclosure.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. When introducing elements of various embodiments of the present disclosure, the articles “a,” “an,” and “the” are intended to mean that there are one or more of the elements. As used herein, the term “and/or” can mean one, some, or all elements depicted in a list. As an example, “A and/or B” can mean A, B, or a combination of A and B.

The term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean are intended to convey that the value being described may be within a relatively small range of the property value, as those of ordinary skill would understand. In particular, the terms “approximately,” “about,” “substantially,” and the like mean within 10% (i.e., plus or minus 10%) of the recited value, within 5% (i.e., plus or minus 5%) of the recited value, or within 2% (i.e., plus or minus 2%) of the recited value.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

As briefly discussed above, a Ventilation Air Methane (“VAM”) mitigation system may be utilized to reduce a concentration of certain gases (e.g., methane) within a VAM stream. For example, traditional VAM mitigation systems may utilize Regenerative Thermal Oxidizers (“RTOs”) to destroy methane or other regulatory volatile gases. An RTO typically includes a fired burner and at least two energy recovery sections (e.g., cannisters), each comprising a ceramic heat exchanging media. In a two-section RTO, for example, one energy recovery section is located at the inlet and the other at the outlet. Accordingly, as a pollutant air stream (e.g., VAM stream) is passed through the RTO and oxidized by the fired burner, the section located at the outlet absorbs progressively more thermal energy since the hot oxidation products pass through its ceramic heat exchanging media. To increase the thermal efficiency of the RTO, airflow switching valves (e.g., poppet valves) may be used to periodically and/or continually reverse the flow of the pollutant air stream (e.g., after a transition period) such that the pollutant air stream entering the RTO is preheated towards its oxidation temperature by the high thermal energy ceramic heat exchanging media of the section previously located at the outlet, thereby “regenerating” the thermal energy of the system.

During the transition mode (e.g., reversal mode) of the RTO, a portion of the pollutant air stream bypasses the RTO (e.g., the fired chamber) entirely through the airflow switching valves with each transition, thereby reducing the destruction efficiency of the RTO. It is also presently recognized that the high energy inputs to reach the operating temperatures of RTO systems (e.g., oxidation temperature, combustion temperature) represent significant operating costs.

Other traditional VAM mitigation systems may utilize catalytic oxidation (e.g., Catalytic VAM oxidation systems) to destroy or reduce regulatory volatile gases from a process stream. Unfortunately, current catalytic VAM oxidation systems, alone, may inherently include reduced efficacy and economic feasibility. For example, the highly stable structure of certain gases (e.g., methane) enables a relatively unaffected pass through traditional catalysts which may be effective at oxidizing other pollutants, such as other volatile organic compounds (e.g., regulatory volatile organic compounds). Further, catalytic VAM oxidation systems may utilize a high amount of thermal energy to enable oxidation of a target gas (e.g., light off temperature). The thermal energy to substantially destroy target gas may render traditional catalytic VAM oxidation systems inefficient for their intended purpose. Susceptibility to catalyst poisons presents yet another barrier to economic feasibility, as traditional catalytic VAM oxidation processes may involve substantial recurring costs associated with replacing or regenerating the catalytic material.

Accordingly, embodiments of the present disclosure relate to a VAM mitigation system which utilizes both an RTO and a catalytic reactor (e.g., a catalyst bed reactor) to destroy an increased amount of methane within a VAM stream, compared to traditional VAM mitigation systems. For example, a VAM stream including methane may be directed into an RTO to thermally oxidize at least a portion of the methane within the VAM stream. Downstream if the RTO, relative to a flow of the VAM stream, the VAM stream may enter a catalytic reactor (e.g., fixed bed reactor, moving bed reactor, slurry bed reactor, catalytic distillation column, etc.) for further destruction of the VAM stream. A methane lean stream exiting (e.g., discharging from) the catalytic reactor may be directed out of the VAM mitigation system via, for example, an exhaust stack. By directing the thermally oxidized VAM stream into a catalyst reactor after the thermal oxidization in the RTO, the VAM mitigation system may experience increased methane destruction (e.g., destruction of >99% weight percentage methane). As will be appreciated, the increased methane destruction of the VAM mitigation system, in accordance with embodiments of the present disclosure, may comply with all current and future environmental regulatory standards. Further, the introduction of the catalytic reactor downstream of the RTO may increase methane destruction of portions of the VAM stream that are not thermally oxidized, due to the inherent transition design of the RTO (e.g., puff).

Embodiments of the present disclosure are also related to the utilization of methane specific catalysts in the catalytic reactor. For example, the catalysts of the present disclosure may enable increased methane oxidation for conversion into water (H₂O) and carbon dioxide (CO₂), compared to catalysts used within traditional VAM mitigation systems. In this way, methane destruction may be increased and the lifetime of the catalysts may be increased, compared to traditional catalysts.

In accordance with present techniques, the flow of the VAM stream through the VAM mitigation system may be directed into one or more heat exchange relationships with downstream streams (e.g., methane lean stream). For example, after thermal oxidization in the RTO and/or catalytic oxidation within the catalytic reactor, the VAM stream (e.g., thermally oxidized VAM stream, catalytically oxidized VAM stream) may include a high amount of thermal energy. As will be appreciated, in order to catalytically oxidize the methane of the VAM stream within the catalytic reactor, a light off temperature (e.g., threshold temperature) of the methane may facilitate a catalytic reaction. As such, one or more recycle streams of the downstream VAM stream containing a high amount of thermal energy may be used to increase the temperature of the VAM stream entering the catalytic reactor, without or with reduced additional thermal energy sources (e.g., additional heaters). As such, the VAM mitigation system may experience increased efficiency (e.g., energy efficiency).

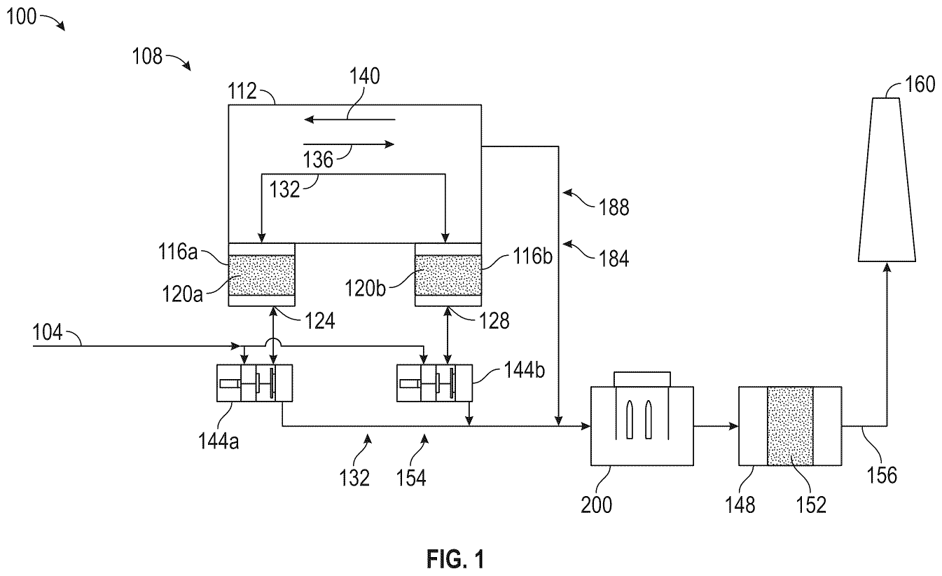

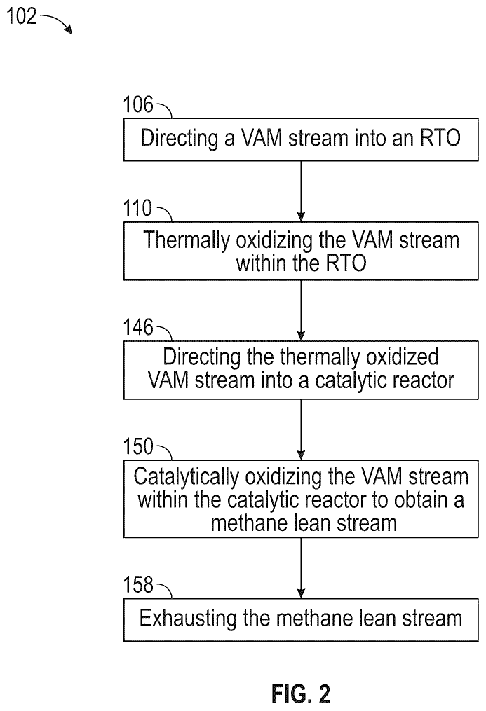

Turning now to the drawings, FIG. 1 illustrates an embodiment of a Ventilation Air Methane (“VAM”) mitigation system 100 (e.g., air purification system) in accordance with the present disclosure. FIG. 2 illustrates a process 102 related to the VAM mitigation system 100 of FIG. 1. To facilitate discussion, FIGS. 1 and 2 will be discussed below concurrently. It should be noted that the process 102 is not limiting, and the VAM mitigation system 100 and/or the process 102 may include additional or fewer steps than those illustrated. Further, the VAM mitigation system 100 and/or process 102 may include steps that are performed in an alternative order to that illustrated in process 102. That is, certain steps may be performed before, after, or concurrently to/with another respective step. As used herein, Ventilation Air Methane, or VAM, refers to methane gas (CH₄) that is released from coal mines during a mining operation. Due to the explosive properties of methane at certain concentrations, airflow may be induced into the mining operation to extract the methane from a subterranean location. For example, the mining operation may include shafts, fans, ducts, and other ventilation systems for circulating airflow through and/or out of the mining operation. Circulating airflow containing methane may be captured at one or more capture points within the mining operation and/or at an above ground location. The captured airflow may be directed into the VAM mitigation system 100 as a VAM stream 104 for processing (e.g., destruction) of the methane. The VAM stream 104 exiting the mining operation or entering the VAM mitigation system 100 may include a methane volume percentage in the range of 0.1% and 2%, but more typically in the range of 0.1% and 1%.

At blocks 106 and 110, the VAM stream 104 may be directed towards, fed, or otherwise provided, and into a Regenerative Thermal Oxidizer (“RTO”) 108 for methane thermal oxidation or destruction. In some embodiments, the RTO 108 may include a fired burner 112 and at least two energy recovery sections 116a, 116b (e.g., cannisters, chambers) each including a heat exchanging media 120a, 120b. In some embodiments, the heat exchanging media 120a, 120b may include a ceramic material (e.g., structured ceramic monoliths, ceramic saddles), a metallic material (e.g., stainless steel, alloy) and/or packed beds (e.g., random packed beds, ceramic saddles, metal rings). The first energy recovery section 116a may be located at a first port 124 (e.g., an inlet) of the RTO 108 and the second energy recovery section 116b may be located at a second port 128 (e.g., an outlet) of the RTO 108.

In general, the VAM mitigation system 100 may be operated in a first configuration or a second configuration, which generally corresponds to a difference in a direction of the flow of the thermally oxidized VAM stream 132. In a first configuration, the VAM stream 104 is directed through the first port 124 of the RTO 108 and further through the first energy recovery section 116a and into the fired burner 112. In the first configuration, after the methane of the VAM stream 104 is oxidized (e.g., thermally oxidized) within the RTO 108 by the fired burner 112, a thermally oxidized VAM stream 132 is directed in a first direction 136 towards and through the second energy recovery section 116b comprising the second heat exchanging media 120b and out of the second port 128. As such, in the first configuration, the first port 124 performs as an inlet to the RTO 108 and the second port 128 performs as an outlet of the RTO 108. As the thermally oxidized VAM stream 132 passes through the second heat exchanging media 120b, the thermally oxidized VAM stream 132 may transfer (e.g., thermally transfer) at least a portion of its thermal energy to the second heat exchanging media 120b. As the VAM stream 104 passes through the first heat exchanging media 120a, the VAM stream 104 may receive (e.g., via a thermal exchange relationship) the thermal energy stored in the first heat exchanging media 120a.

The RTO 108 may be configured to transition from the first configuration to a second configuration to increase thermal efficiency. In a second configuration, the VAM stream 104 is directed through the second port 128 of the RTO 108 and further through the second energy recovery section 116b and into the fired burner 112. As such, the RTO 108 may include one or more airflow switching valves 144a, 144b, (e.g., poppet valves) configured to reverse the flow of the VAM stream 104, reversing the flow of the thermally oxidized VAM stream 132 from a first direction 136 to a second direction 140 or vice versa. For example, the VAM stream 104 may be directed into a first airflow switching valve 144a and/or the second airflow switching valve 144b before being directed into the RTO 108 via the first port 124 or the second port 128. During a transition period, the first and second airflow switching valves 144a, 144b may “switch,” changing the RTO 108 from the first configuration to the second configuration or vice versa.

For example, after switching the airflow switching valves 144a, 144b from the first configuration to the second configuration (e.g., via control signals transmitted by a controller), the VAM stream 104 is directed through the second port 128 of the RTO 108 and further through the second energy recovery section 116b and into the fired burner 112. In the second configuration, after the methane of the VAM stream 104 is oxidized (e.g., thermally oxidized) within the RTO 108, a thermally oxidized VAM stream 132 is directed in the second direction 140 towards and through the first energy recovery section 116a comprising the first heat exchanging media 120a and out of the first port 124. As such, in the second configuration, the first port 124 performs as an outlet to the RTO 108 and the second port performs as an inlet of the RTO 108. As the thermally oxidized VAM stream 132 passes through the first heat exchanging media 120a, the thermally oxidized VAM stream 132 may transfer (e.g., thermally transfer) at least a portion of its thermal energy to the first heat exchanging media 120a. As the VAM stream 104 passes through the second heat exchanging media 120b, the VAM stream 104 may receive (e.g., via a thermal exchange relationship) thermal energy stored in the second heat exchanging media 120b. The regenerative nature of the first and second energy recovery sections 116a, 116b may facilitate the first and second heat exchanging media 120a, 120b to transfer at least a portion of the thermal energy utilized for thermal oxidization to the VAM stream 104, without the fired burner 112. As such, the fired burner 112 may experience reduced energy consumption in thermally oxidizing the methane from the VAM stream 104.

In some embodiments, the RTO 108 may include a bypass conduit 184 (hot gas bypass conduit) configured to direct at least a portion of the VAM stream 104 and/or the thermally oxidized VAM stream 132 around the first or second energy recovery sections 116a, 116b and the respective heat exchanging media 120a, 102b. For example, the bypass conduit 184 may extend from the fired burner 112 upstream of a respective outlet port (e.g., second port 128 in the first configuration of the RTO 108, first port 124 in the second configuration of the RTO 108). As such, by bypassing the heat exchanging media 120a, 120b, a bypass stream 188 (e.g., hot gas bypass stream) directed through the bypass conduit 184 may maintain increased thermal energy compared to the thermally oxidized VAM stream 132 directed through the heat exchanging media 120a, 120b. As will be appreciated, the bypass stream 188 may include a volume percentage of flow (e.g., VAM flow) in the range of 25% to 30% of the VAM stream 104 entering the RTO. Advantageously, the bypass stream 188 may include a relatively high amount of thermal energy and a relatively low volume compared to the VAM stream 104 or the thermally oxidized VAM stream 132. As such, the bypass stream 188 may be configured to combine (e.g., combine downstream of the RTO 108) with the thermally oxidized VAM stream 132 upstream to the catalytic reactor 148, thereby desirably increasing the temperature of the thermally oxidized VAM stream 132. In this way, the thermally oxidized VAM stream 132 may be heated to a temperature equal to or greater than the threshold temperature utilized for catalytic oxidation or methane. By directing the bypass stream 188 to increase the temperature of the thermally oxidized VAM stream 132, additional heat exchanging equipment (e.g., optional heater 200) may be reduced in size, may be operating at reduced capacity, and/or may be omitted from the VAM mitigation system 100, thereby increasing energy efficiency.

At blocks 146 and 150, after oxidation within the RTO 108, the thermally oxidized VAM stream 132 may exit the RTO 108 (e.g., via the first port 124 when the VAM mitigation system 100 operates in accordance with the first configuration or the second port 128 when the VAM mitigation system 100 operates in accordance with the second configuration) and may be directed into a catalytic reactor 148 for catalytic oxidation of the methane within the thermally oxidized VAM stream 132. The catalytic reactor 148 may include a fixed bed catalyst configured to enable continuous flow of the thermally oxidized VAM stream 132 through the catalytic reactor 148 for continuous methane destruction. For example, the catalytic reactor 148 may include a cylindrical shape with an input end and an output end, configured to house a catalyst 152 (e.g., catalyst pellets). The catalyst 152 may be a methane catalyst configured to catalytically oxidize the methane within the thermally oxidized VAM stream 132. The catalyst 152 may include any suitable substrate, such as, wire mesh, sheet metal, monolithic ceramic material, or a combination thereof. As will be appreciated, in order for methane within the thermally oxidized VAM stream 132 to be further catalytically oxidized in the catalytic reactor 148, a light off temperature (e.g., catalytic oxidation temperature) of the methane is utilized. As such, the thermally oxidized VAM stream 132 must include a temperature equal to or greater than a threshold temperature utilized for catalytic oxidation. Advantageously, after thermal oxidation of the VAM stream 104 within the RTO 108, the thermally oxidized VAM stream 132 may utilize a reduced input of thermal energy to reach the threshold temperature utilized for catalytic oxidation, due to the previously performed thermal oxidation.

In some embodiments, the methane concentration (e.g., volume concentration) within the thermally oxidized VAM stream 132 may be equal to or less than 0.3% by volume (vol. %). For example, the methane concentration may be less than or equal to 0.3 vol. %, less than or equal to 0.25 vol. %, less than or equal to 0.2 vol. %, between 0.01 and 0.3 vol. %, between 0.01 and 0.2 vol. %, between 0.1 and 2 vol. %. In this way, within this methane concentration, it is presently recognized that, after direction into the catalytic reactor direction into the catalytic reactor 148, the catalyst 152 (e.g., methane catalyst) may efficiently enable catalytic oxidation of the methane. Thus, the catalytic reactor 148 may operate more efficiently and/or the lifetime of the catalyst 152 may increase.

The thermally oxidized VAM stream 132 may enter an optional heater 200 configured to transfer thermal energy to the thermally oxidized VAM stream 132 to desirably increase the temperature of the thermally oxidized VAM stream 132. As such, the optional heater 200 may aid in increasing the temperature of the thermally oxidized VAM stream 132 to a temperature equal to or greater than the threshold temperature utilized for catalytic oxidation. The optional heater 200 may be any heater suitable for raising a temperature of the thermally oxidized VAM stream 132, such as, an electric heater, fired heater, a second heat exchanger, and/or another suitable heater. In some embodiments, the optional heater 200 may receive energy from a natural gas stream, similar to natural gas stream 172. In some embodiments, the natural gas stream may be sourced from the same mine operation as the VAM stream 104, for example, coal mine methane, or mine drainage.

Although the catalytic reactor 148 is discussed in the present disclosure as including a fixed bed reactor, it will be appreciated the catalytic reactor 148 is not limiting, and can include other types, configurations, sizes, and/or parameters. For example, the catalytic reactor 148 may include a packed bed reactor (e.g., fixed pack bed reactor, moving packed bed reactor), a fluidized bed reactor, a slurry bed reactor, a monolithic reactor, or a membrane reactor. The catalytic reactor 148 may include any dimensions suitable to receive an increased mass flow rate of the thermally oxidized VAM stream 132. Indeed, the size of the catalytic reactor 148 may depend on the mass flow rate of the thermally oxidized VAM stream 132, the size (e.g., volume) of the RTO 108, the type of catalyst 152, and/or another parameter.

As will be appreciated, the positioning of the catalytic reactor 148 downstream the RTO 108, relative to a direction of the VAM stream flow, enables methane capture and destruction of a bypass VAM stream 154. As discussed above, during the transition period of the RTO 108, at least a portion of the VAM stream 104 (e.g., bypass VAM stream 154) may bypass the fired burner 112 of the RTO 108, thereby bypassing thermal oxidization within the VAM mitigation system 100. Specifically, during the transition period (e.g., switching from the first configuration to the second configuration of the RTO 108) the VAM stream 104 may enter the first and/or second airflow switching valves 144a, 144b, to be directed away from the RTO 108 as the bypass VAM stream 154. As will be appreciated, the bypass VAM stream 154 and the thermally oxidized VAM stream 132 may be directed along the same conduit towards the catalytic reactor 148. By bypassing the RTO 108, and thermal oxidization of methane, the bypass VAM stream 154 may include an undesirable amount of methane. Advantageously, the location of the catalytic reactor 148 downstream of the RTO 108 may enable capture and destruction of the undesirable methane within the bypass VAM stream 154 following the transition period of the RTO 108. In this way, VAM mitigation system 100 may not include additional elements (e.g., puff chamber, puff chamber system) traditionally utilized to destroy harmful gases within a bypass stream caused by a transition period of the RTO 108. As such, the VAM mitigation system 100 may experience reduced costs (e.g., components costs) and increased methane destruction efficiency.

The catalytic reactor 148 may perform similar catalytic oxidization of the bypass VAM stream 154 as discussed above for the thermally oxidized VAM stream 132. However, by bypassing the fired burner 112 and thermal oxidization, the bypass VAM stream 154 may include reduced thermal energy compared to the thermally oxidized VAM stream 132. As such, one or more additional heat exchanging elements (e.g., optional heater, heat exchanger) may be disposed upstream to the catalytic reactor 148, configured to transfer thermal energy to the bypass VAM stream 154, increasing a temperature of the bypass VAM stream 154 to a temperature equal to or greater than the threshold temperature utilized to catalytically oxidize the methane within the catalytic reactor 142. In some embodiments, control of the additional heating elements may be at least partially based on an operational parameter of the RTO 108 (e.g., fired burner 112 temperature), an operational mode of the RTO 108 (e.g., first configuration, second configuration, transition period), and/or any other suitable parameter.

In any case, in block 158, a methane lean stream 156 (catalytically oxidized VAM stream, methane lean VAM stream) is directed out of the catalytic reactor 148 to be directed out or exhausted from the VAM mitigation system 100. For example, the methane lean stream 156 may be directed through an exhaust stack 160. In some embodiments, the exhaust stack 160 may include one or more sensors configured to detect a concentration of one or more compounds within the methane lean stream 156 exiting the VAM mitigation system 100. For example, at least one sensor may be configured to detect a concentration of methane (e.g., weight concentration, volume concentration, molecular concentration), where the sensor may send a signal indicative of the methane concentration to one or more controllers of the VAM mitigation system 100. The one or more controllers of the VAM mitigation system 100 may be configured to operate (e.g., adjust, power on, power off) one or more elements of the VAM mitigation system 100 based on the signal. For example, after a determination that the methane concentration is above a threshold, the one or more controllers may adjust (e.g., increase) a temperature of the thermally oxidized VAM stream 132 (e.g., via optional heat exchanging components) entering the catalytic reactor 148 to increase catalytic oxidization of methane.

In some embodiments, a flare stack may be used alone or in combination with the exhaust stack 160 to burn excess gases within the methane lean stream 156 after exit of the VAM mitigation system 100. For example, after catalytic oxidation in the catalytic reactor 148, the methane lean stream 156 may be directed towards a flare stack to be combusted in the presence of an oxidizing as (e.g., air, oxygen).

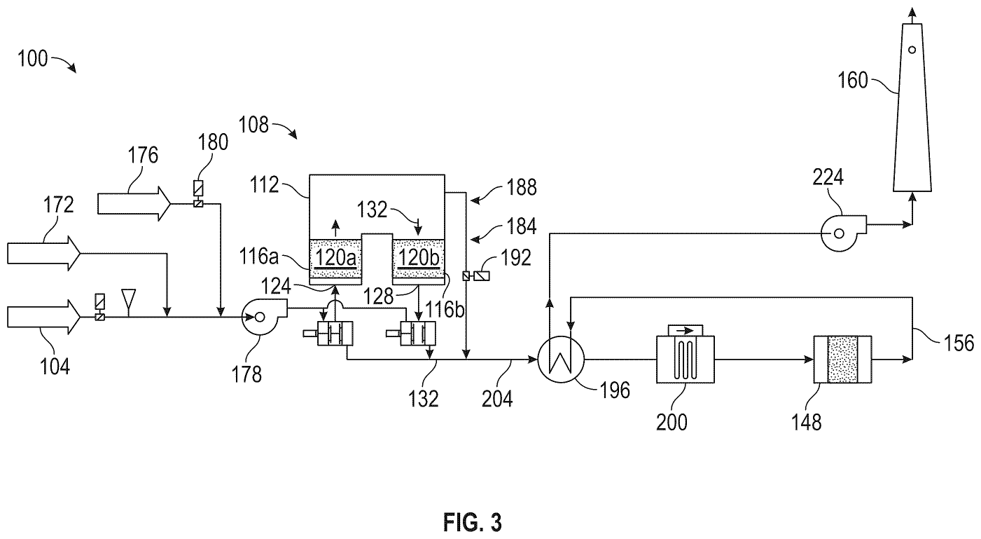

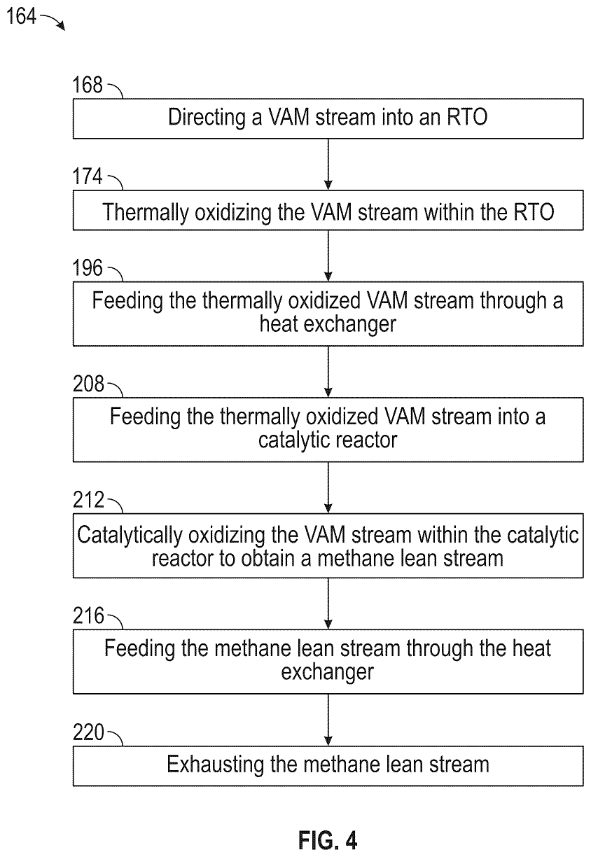

Turning now to FIG. 3 an embodiment of a VAM mitigation system 100 in accordance with the present disclosure is shown. FIG. 4 illustrates a process 164 related to the VAM mitigation system 100 of FIG. 3. To facilitate discussion of the VAM mitigation system 100, FIGS. 3 and 4 will be discussed below concurrently. It should be noted that the process 164 is not limiting, and the VAM mitigation system 100 and/or the process 164 may include additional or fewer steps than those illustrated. Further, the VAM mitigation system 100 and/or process 164 may include steps that are performed in an alternative order to that illustrated in process 164. That is, certain steps may be performed before, after, upstream, downstream, and/or concurrently to/with another respective step. The VAM mitigation system 100 illustrated in FIG. 3 may have similar elements and element numbering as that of FIG. 1. For example, at blocks 168 and 174, the VAM stream 104 from a mining operation may be directed towards and into the RTO 108 for methane oxidation or destruction in a generally similar manner as described above with reference to block 106 of FIG. 1. In the illustrated embodiment, the VAM stream 104 may be supplemented with one or more process streams.

For example, a natural gas stream 172 may be combined with the VAM stream 104 upstream, relative a flow of the VAM stream 104, thermal oxidation within the RTO 108. The natural gas stream 172 may include combustible gases (e.g., hydrocarbons, propane, ethane, butane, etc.) that may aid in oxidation of methane in the fired burner 112 of the RTO 108. That is, in some embodiments, the concentration of methane within the VAM stream 104 may be below a combustible concentration threshold. As such, the addition of the natural gas stream 172 to the VAM stream 104 may enable combustion of the VAM stream 104 within the RTO 108, destroying methane. In some embodiments, the natural gas stream 172 may be sourced from the same mine operation as the VAM stream 104, for example, coal mine methane, or mine drainage. In other embodiments, the natural gas stream 172 may be sourced separate from the mining operation.

In addition, or as an alternative to the natural gas stream 172, an airflow stream 176 (e.g., ambient airflow stream) may be combined with the VAM stream 104 upstream, relative a flow of the VAM stream 104, thermal oxidation in the RTO 108. Similar to the natural gas stream 172, the airflow stream 176 may aid in thermal oxidation of methane in the fired burner 112 of the RTO 108. In some embodiments, the airflow stream 176 may only be combined with the VAM stream 104 during certain operational modes of the VAM mitigation system 100 and/or the RTO 108. For example, the VAM mitigation system 100 may include an airflow damper 180 configured to enable or disable flow of the airflow stream 176 into the VAM stream 104. For example, during a start-up mode of the VAM mitigation system 100, the airflow damper 180 may actuate to an open position, enabling the airflow stream 176 to combine with the VAM stream 104 prior to the RTO 108. Likewise, during a shut-down mode of the VAM mitigation system 100, the airflow damper 180 may actuate to an open position, enabling the airflow stream 176 to combine with the VAM stream 104 prior to the RTO 108. In a normal operating mode (e.g., not start-up or shut down) of the VAM mitigation system 100, the airflow damper 180 may actuate to a closed position to disable flow of the airflow stream 176 into VAM stream 104.

In some embodiments, the VAM mitigation system 100 may include a first process blower 178 (e.g., fan) configured to induce the VAM stream 104, with or without the addition of the natural gas stream 172 and the airflow stream 176, to the RTO 108. In any case, at block 168, the VAM stream 104 may be directed through the RTO 108 in a generally similar manner as described with reference to block 106 of FIG. 1. Although FIG. 3 illustrates the RTO 108 in the first configuration (e.g., VAM stream 104 entering through the first port 124 and exiting through the second port 128), it will be appreciated the RTO 108 may transition to a second configuration (VAM stream 104 entering through the second port 128 and exiting through the first port 124).

As discussed above, the VAM mitigation system 100 may include a bypass conduit 184 configured to direct at least a portion of the VAM stream 104 away from the fired burner 112 as a bypass stream 188. In some embodiments, the bypass conduit 184 may further include a bypass damper 192 (e.g., hot gas bypass damper) configured to regulate the flow of the bypass stream 188 out of the fired burner 112. For example, the bypass damper 192 may be communicatively coupled to one or more controllers of the VAM mitigation system 100, and the bypass damper 192 may be configured to actuate to a desired position (e.g., open, closed, partially open) in response to a signal from the controller.

In any case, the thermally oxidized VAM stream 132, with or without the bypass stream 188, may be directed through a heat exchanger 196 configured to increase the temperature of the thermally oxidized VAM stream 132. That is, the heat exchanger 196 may be configured to place the thermally oxidized VAM stream 132 into a heat exchange relationship with a second stream (e.g., the methane lean stream 156) such that the second stream may transfer at least a portion of its thermal energy to the thermally oxidized VAM stream 132. In some embodiments, the second stream may be a stream recycled from a downstream location of the VAM mitigation system 100, as will be discussed below. By utilizing a recycled stream from a downstream location, the VAM mitigation system 100 may experience reduced energy consumption resulting from increasing the temperature of the thermally oxidized VAM stream 132 to a temperature equal to or greater than the threshold temperature utilized for catalytic oxidization of methane in the catalytic reactor 148.

The heat exchanger 196 may be any suitable heat exchanger configured to place a first stream (e.g., thermally oxidized VAM stream 132) in a heat exchange relationship with a second stream. For example, a shell and tube heat exchange and/or a plate heat exchanger may be utilized to fluidly separate the first stream from the second stream while enabling heat transfer between the two streams.

As discussed above, the thermally oxidized VAM stream 132 may enter an optional heater 200 configured to transfer thermal energy to the thermally oxidized VAM stream 132 to desirably increase the temperature of the thermally oxidized VAM stream 132. In some embodiments, the natural gas stream may be sourced from the same mine operation as the VAM stream 104, for example, coal mine methane, or mine drainage.

The optional heater 200 may be communicatively coupled to a controller of the VAM mitigation system 100 such that the controller may operate to adjust operation of the optional heater 200 based on one or more parameters of the VAM mitigation system 100. For example, after determining, via the controller, that the temperature of the thermally oxidized VAM stream 132 is equal to or greater than the threshold temperature (e.g., light off temperature) utilized for catalytic oxidization, the controller may send a control signal to the optional heater 200 to suspend operation. As another non-limiting example, after determining, via the controller, that the temperature of the thermally oxidized VAM stream 132 is less than the threshold temperature utilized for catalytic oxidization, the controller may send a control signal to the optional heater 200 to enable operation. In some embodiments, operation of the optional heater 200 may depend on a deviation (e.g., difference) between the temperature of the thermally oxidized VAM stream 132 and the threshold temperature utilized for catalytic oxidization. For example, the controller may instruct the optional heater 200 to operate at a reduced capacity (e.g., less than 100% capacity, less than 95% capacity, less than 90% capacity, less than 80% capacity) after a determination that the deviation between the temperature of the thermally oxidized VAM stream 132 and the threshold temperature is within a threshold deviation (e.g., within 5 degrees). In such embodiments, the determination of the temperature of the thermally oxidized VAM stream 132 may be based on the temperature detected via one or more sensors disposed along a conduit 204 extending between the RTO 108 and the catalytic reactor 148.

As will be appreciated, due to the heat transfer of the heat exchanger 196, the optional heater 200 may operate at a reduced capacity or may suspend operation, reducing energy consumption. Although the optional heater 200 is illustrated as disposed downstream of the heat exchanger 196, it will be appreciated the optional heater 200 may be disposed anywhere within the VAM mitigation system 100, such as upstream of the heat exchanger 196.

In blocks 208 and 212, the thermally oxidized VAM stream 132 is directed, fed, or otherwise provided to the catalytic reactor 148, where the catalytic reactor 148 may destroy (e.g., oxidize) at least a portion of the remaining methane, in a generally similar manner as discussed above with reference blocks 146 and 150 of FIGS. 1 and 2. After catalytic oxidization of the thermally oxidized VAM stream 132, a methane lean stream 156 may be directed out from the catalytic reactor 148. It will be appreciated that the methane lean stream 156 may include a methane concentration (e.g., volume concentration) of less than 1% of the total volume. As such, the exhausted methane lean stream 156 may result in reduced harm to the environment, compared to other VAM mitigation system. Further, the exhausted methane lean stream 156 may comply with present and future environmental regulation related to gas exhaust, without the need of additional methane destruction components or methods.

In block 216, the methane lean stream 156 may be directed (e.g., recycled) to the heat exchanger 196 to be put in a heat exchange relationship with the upstream thermally oxidized VAM stream 132 as discussed above. As will be appreciated, catalytic oxidization of methane within the catalytic reactor 148 may produce excess thermal energy as a byproduct of the reaction. As such, the methane lean stream 156 exiting the catalytic reactor 148 may include high thermal energy, compared to the thermally oxidized VAM stream 132 entering the catalytic reactor 148. By directing the methane lean stream 156 into the heat exchanger 196 and into a heat exchange relationship with the thermally oxidized VAM stream 132, the methane lean stream 156 may transfer at least a portion of its thermal energy to the thermally oxidized VAM stream 132. As such, the temperature of the thermally oxidized VAM stream 132 may desirably increase towards a temperature equal to or greater than the threshold temperature utilized for catalytic oxidation of methane. Therefore, the additional heating components, (e.g., the optional heater 200) may suspend operation or operate at a reduced capacity, thereby reducing energy consumption and increasing the efficiency of the VAM mitigation system 100.

At block 220, the methane lean stream 156 may be directed through an exhaust stack 160 in a generally similar manner as discussed above with reference to block 158 of FIG. 2. In some embodiments, additional process blowers, such as second process blower 224, may be incorporated into the VAM mitigation system 100 to aid in exhaustion of the methane lean stream 156.

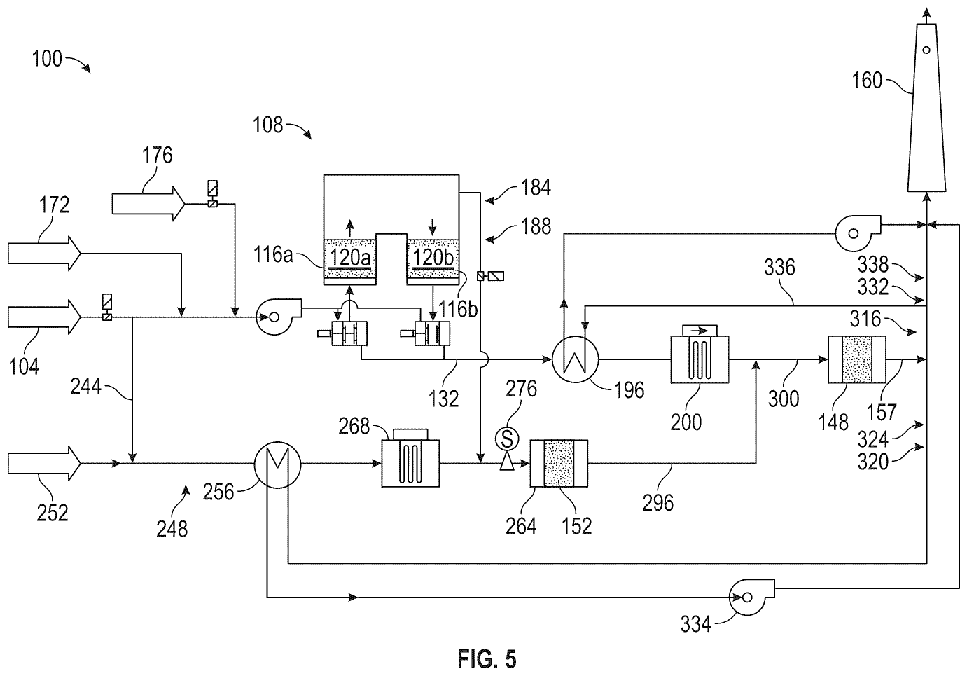

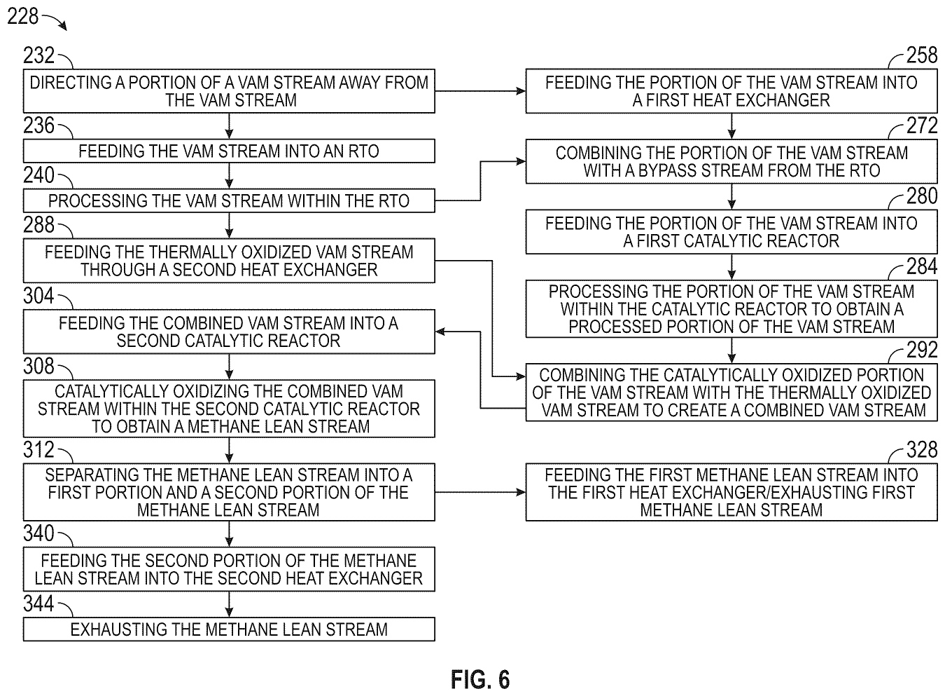

Turning now to FIG. 5 an embodiment of a VAM mitigation system 100 in accordance with the present disclosure is shown. FIG. 6 illustrates a process 228 related to the VAM mitigation system 100 of FIG. 5. To facilitate discussion of the VAM mitigation system 100, FIGS. 5 and 6 will be discussed below concurrently. It should be noted that the process 228 is not limiting, and the VAM mitigation system 100 and/or the process 228 may include additional or fewer steps than those illustrated. Further, the VAM mitigation system 100 and/or process 228 may include steps that are performed in an alternative order to that illustrated in process 228. That is, certain steps may be performed before, after, upstream, downstream, and/or concurrently to/with another respective step. The VAM mitigation system 100 illustrated in FIG. 5 may have similar elements and element numbering as that of any of the preceding figures. For example, at blocks 236 and 240, the VAM stream 104 from a mining operation may be directed towards and into the RTO 108 for thermal oxidation or destruction of methane in a generally similar manner as described above with reference to block 110 of FIG. 2. In the illustrated embodiment, the VAM stream 104 may be supplemented with one or more process streams as described in detail above. For example, the VAM stream may be supplemented with a natural gas stream 172 and/or an airflow stream 176.

In the illustrated embodiment of the VAM mitigation system 100, at block 232, at least a portion (e.g., second VAM stream 244) of the VAM stream 104 may be directed away from the VAM stream 104 (e.g., via one or more dampers (e.g., butterfly dampers and/or louver dampers) communicatively coupled to a controller) and through a secondary oxidization section 248 (e.g., bypass section) configured to thermally and/or catalytically oxidize the methane within the second VAM stream 244 separate from thermal oxidization in the RTO 108. In some embodiments, the second VAM stream 244 may be directed away from the VAM stream 104 downstream, relative to a flow of the VAM stream 104, of the addition of one or more supplemental streams (e.g., natural gas stream 172 and/or airflow stream 176) such that the second VAM stream 244 includes a portion of the supplemental streams. In other embodiments, the second VAM stream 244 may be directed away from the VAM stream 104 upstream of the addition of the supplemental streams. As such, additional supplemental streams may be added to the second VAM stream 244 within the secondary oxidization section 248. For example, an additional natural gas stream 252 and/or an additional airflow stream may be supplemented to the second VAM stream 244 within the secondary oxidization section 248. In any case, the second VAM stream 244 may bypass thermal oxidation within the RTO 108.

In any case, the second VAM stream 244 directed away from the VAM stream 104 may include 5% (e.g., by weight (wt %) or volume (vol. %)) of the VAM stream 104, more preferably 10%, more preferably 15%, more preferably 20%, and most preferably 25%. Advantageously, by bypassing a percentage of the VAM stream 104 from the RTO 108, the VAM mitigation system 100 may experience reduced component costs. For example, by bypassing a portion of the VAM stream 104 around the RTO 108, the RTO 108 may be reduced in size (e.g., combustion chamber volume, heat exchanging media size/quantity, etc.) thereby reducing cost of manufacture or purchase. For example, in embodiments with the second VAM stream 244 comprising 25% of the VAM stream 104, the VAM stream 104 may experience a 25% reduction in a mass flow rate, as such, the RTO 108 may experience a reduction in size and/or operating capacity to accommodate the reduced mass flow rate. Further, in embodiments traditionally requiring two or more RTOs, the reduced mass flow rate of the entering VAM stream 104 may result in a reduction (e.g., by 1, 2, 3, etc.) of the number of RTOs used, thereby reducing costs.

In some embodiments, the mass flow rate and/or the percentage of flow relative to the VAM stream 104 of the second VAM stream 244 may be partially based on an amount (e.g., mass flow rate, percentage) of gas bypassed through the bypass conduit 184. As discussed above, the RTO 108 may include a bypass conduit 184 configured to direct a bypass stream 188 from the fired burner 112 to a location downstream of the heat exchanging media 120a, 120b, effectively bypassing heat transfer within the first and second energy recovery sections 116a, 116b. As such, mass flow rate of the second VAM stream 244, relative to the VAM stream 104, may be partially based on an amount (e.g., mass flow rate, percentage) of flow bypassed as the bypass stream 188.

At block 258, within the secondary oxidation section 248, the second VAM stream 244 may be directed, fed, or provided into a heat exchanger 256 (e.g., first heat exchanger). That is, the heat exchanger 256 may be configured to place the second VAM stream 244 into a heat exchange relationship with a second stream such that the second stream may transfer at least a portion of its thermal energy to the second VAM stream 244. In some embodiments, the second stream may be a stream recycled from a downstream location of the VAM mitigation system 100 similar to the configuration of the heat exchanger 196, discussed above. By utilizing a recycled stream from a downstream location, the VAM mitigation system 100 may experience reduced energy consumption in increasing the temperature of the second VAM stream 244 to a temperature equal to or greater than a threshold temperature utilized for catalytic oxidization of methane in the catalytic reactor 148 (e.g., second catalytic reactor) and/or catalytic reactor 264 (e.g., first catalytic reactor).

The heat exchanger 256 may be any suitable heat exchanger configured to place a first stream (e.g., second VAM stream 244) in a heat exchange relationship with a second stream. For example, a shell and tube heat exchange and/or a plate heat exchanger may be utilized to fluidly separate the first stream from the second stream while enabling heat transfer between the two streams.

The second VAM stream 244 may enter an optional heater 268 (e.g., first optional heater) configured to transfer thermal energy to the second VAM stream 244 to desirably increase the temperature of the second VAM stream 244. As such, the optional heater 268 may aid in increasing the temperature of second VAM stream 244 to a temperature equal to or greater than the threshold temperature utilized for catalytic oxidization of methane in the catalytic reactor 264. The optional heater 268 may be any heater suitable for raising a temperature of the second VAM stream 244, such as, an electric heater, fired heater, a second heat exchanger, and/or another suitable heater.

At block 272, the bypass stream 188 of the RTO 108 may be configured to combine with the second VAM stream 244 upstream to the catalytic reactor 148, thereby desirably increasing the temperature of the second VAM stream 244. For example, and as shown in FIG. 5, the bypass stream 188 may be combined with the second VAM stream 244 after the second VAM stream 244 is heated with the optional heater 268. In this way, the second VAM stream 244 may be heated to a temperature equal to or greater than the threshold temperature utilized for catalytic oxidation of methane. By directing the bypass stream 188 to increase the temperature of the second VAM stream 244, additional heat exchanging equipment may be reduced in size and/or may operate at a reduced capacity. As described in more detail below, the optional heater 268 may be removed in an embodiment where the bypass stream 188 is combined with the second VAM stream 244.

For example, in some embodiments, the bypass stream 188 may provide a sufficient amount of thermal energy to the second VAM stream 244 such that the optional heater 268 may be reduced in size or omitted from the VAM mitigation system 100 entirely, thereby reducing components costs. In some embodiments, the optional heater 268 may be operated (e.g., controlled) based on a temperature of the second VAM stream 244 after addition of the bypass stream 188. For example, the VAM mitigation system 100 may include a sensor 276 disposed downstream of the combination point of the second VAM stream 244 and the bypass stream 188. A controller of the VAM mitigation system 100 may be configured to receive a signal from the sensor 276 indicative of the temperature of the second VAM stream 244. After receiving the signal indicative of the temperature of the second VAM stream 244, the controller may send a signal to one or more components of the VAM mitigation system 100, such as the optional heater 268, to control operation (e.g., turn on, turn off, operate at a middle capacity), based on the temperature of the second VAM stream 244.

At blocks 280 and 284, the second VAM stream 244 may be directed into a catalytic reactor 264 (e.g., first catalytic reactor) in the secondary oxidation section 248 for catalytic oxidation of the methane within the second VAM stream 244. In some embodiments, the catalytic reactor 264 may include similar structural and/or operational parameters as mentioned above for the catalytic reactor 148 (e.g., second catalytic reactor). In some embodiments, the catalytic reactor 264 may include a reduced size relative to the catalytic reactor 148, due to the reduced flow rate of the second VAM stream 244. For example, the size (e.g., physical dimensions) of the catalytic reactor 264 may be approximately 25%, 35%, 45%, or 50% smaller than the catalytic reactor 148. For example, the size of the catalytic reactor 264 may be between approximately 25-50% smaller than the size of the catalytic reactor 148. Indeed, the size and the operating parameters of the catalytic reactor 264 may at least partially depend on a flow rate of the second VAM stream 244. Furthermore, the catalytic reactor 264 may include the catalyst 152 configured to facilitate catalytic oxidation of the methane within the second VAM stream 244. In some embodiments, the catalyst 152 is a methane catalyst and may be supported by one or more materials, such as a zeolite, silica, alumina, or a combination thereof. The catalyst 152 may include any suitable substrate, such as, wire mesh, sheet metal, monolithic ceramic material, or a combination thereof.

Returning to blocks 240 and 288, after thermal oxidization of the VAM stream 104 within the RTO 108, the thermally oxidized VAM stream 132 may be directed through the heat exchanger 196 to desirably increase the temperature of the thermally oxidized VAM stream 132, as discussed in detail above. That is, the heat exchanger 196 may be configured to place the thermally oxidized VAM stream 132 into a heat exchange relationship with a second stream such that the second stream may transfer at least a portion of its thermal energy to the thermally oxidized VAM stream 132.

At block 292, a catalytical oxidized second VAM stream 296 may be directed from the catalytic reactor 264 of the secondary oxidation section 248 to be combined with the thermally oxidized VAM stream 132, where catalytical oxidized second VAM stream 296 and the thermally oxidized VAM stream 132 at least partially define a combined stream 300. For example, the catalytical oxidized second VAM stream 296 and the thermally oxidized VAM stream 132 may be combined downstream of the heat exchanger 196, the optional heater 200 or both. In some embodiments, the catalytical oxidized second VAM stream 296 and the thermally oxidized VAM stream 132 may be combined upstream of the heat exchanger 196, the optional heater 200 or both. In order to catalytically oxidize the methane within the combined stream 300, the combined stream 300 may include a temperature that is equal to or greater than the threshold temperature utilized for catalytic oxidation in the catalytic reactor 148. As such, one or more components (e.g., bypass damper 192, optional heaters 200, 268) of the VAM mitigation system 100 may be controlled based on the temperature of the combined stream 300.

At blocks 304 and 308, the combined stream 300 may be fed or directed into the catalytic reactor 148 (e.g., second catalytic reactor) for catalytic oxidation of the methane within the combined stream 300 in a matter similar to that described above.

At block 312, the methane lean stream 156 exiting the catalytic reactor 148 may be partitioned or separated into a first methane lean stream 316 (e.g., first portion of the methane lean stream) and a second methane lean stream 320 (e.g., second portion of the methane lean stream). For example, a conduit extending from the outlet of the catalytic reactor 148 may include a juncture 324 configured to split or separate the methane lean stream 156 into the first methane lean stream 316 and the second methane lean stream 320. In some embodiments, the conduit extending from the outlet of the catalytic reactor 148 may include a damper (e.g., valve), such as a divertor or multi-port valve, configured to fluidly separate the first methane lean stream 316 from the second methane lean stream 320. In some embodiments, the damper may be communicatively coupled to the controller of the VAM mitigation system 100 and configured to selectively partition the methane lean stream 156 into the first methane lean stream 316 and the second methane lean stream 320. For example, the controller may send a signal to the damper, where the damper may actuate to selectively partition a percentage (e.g., percentage of the mass flow rate) of the methane lean stream 156 into the first methane lean stream 316 and a percentage into the second methane lean stream 320. In this way, the controller of the VAM mitigation system 100 may regulate mass flow rate, and therefore thermal energy transfer, within the (first) catalytic reactor 264, the (second) catalytic reactor 148, or both.

At block 328, the first methane lean stream 316 may be directed (e.g., recycled) to the heat exchanger 196 to be put in a heat exchange relationship with the upstream thermally oxidized VAM stream 132, as discussed above, and/or may be exhausted out of the VAM mitigation system 100 via the exhaust stack 160. For example, the VAM mitigation system 100 may include a second juncture 332 configured to partition the first methane lean stream 316 into a recycled first methane lean stream 336 and an exhausted first methane lean stream 338. The recycled first methane lean stream 336 may include excess thermal energy, compared to the thermally oxidized VAM stream 132 and/or the combined stream 300 entering the catalytic reactor 148. By directing the recycled first methane lean stream 336 into the heat exchanger 196 and into a heat exchange relationship with the thermally oxidized VAM stream 132 and/or combined stream 300, the recycled first methane lean stream 336 may transfer at least a portion of its thermal energy to the thermally oxidized VAM stream 132 and/or the combined stream 300. As such, the temperature of the thermally oxidized VAM stream 132 and/or combined stream 300 may desirably increase towards a temperature equal to or greater than the threshold temperature utilized for catalytic oxidation (e.g. light off temperature). After thermal energy transfer in the heat exchanger 196, the recycled first methane lean stream 336 may be combined (e.g., combined upstream of the second juncture 332) with the exhausted first methane lean stream 338 to be exhausted or directed out of the VAM mitigation system 100.

At block 340, the second methane lean stream 320 may be directed (e.g., recycled) to the heat exchanger 256 (e.g., first heat exchanger) to put the second methane lean stream 320 in a heat exchange relationship with the second VAM stream 244 upstream of the catalytic reactor 264. As will be appreciated, catalytic oxidization of methane within the catalytic reactor 148 may produce excess thermal energy as a byproduct of the reaction. As such, the second methane lean stream 320 exiting the catalytic reactor 148 may include excess thermal energy, compared to the second VAM stream 244 entering the catalytic reactor 264. By directing the second methane lean stream 320 into the heat exchanger 256 and into a heat exchange relationship with the second VAM stream 244, the second methane lean stream 320 may transfer at least a portion of its thermal energy to the second VAM stream 244. As such, the temperature of the second VAM stream 244 may desirably increase towards a temperature equal to or greater than the threshold temperature utilized for catalytic oxidation of methane within the catalytic reactor 264. Therefore, additional heating components (e.g., the optional heater 268) may suspend operation or operate at a reduced capacity, thereby reducing energy consumption and increasing the efficiency of the VAM mitigation system 100. Alternatively or additionally, supplemental heating streams, (e.g., bypass stream 188) may be reduced (e.g., reduced in mass flow rate), enabling increased thermal oxidation in the RTO 108 and/or redistribution of the supplemental heating streams to other locations of the VAM mitigation system 100.

At block 344, the second methane lean stream 320 may then be directed through an exhaust stack 160, alone or in combination with the first methane lean stream 316. In some embodiments, additional process blowers, such as the third process blower 334, may be incorporated into the VAM mitigation system 100 to aid in exhaustion of the second methane lean stream 320.

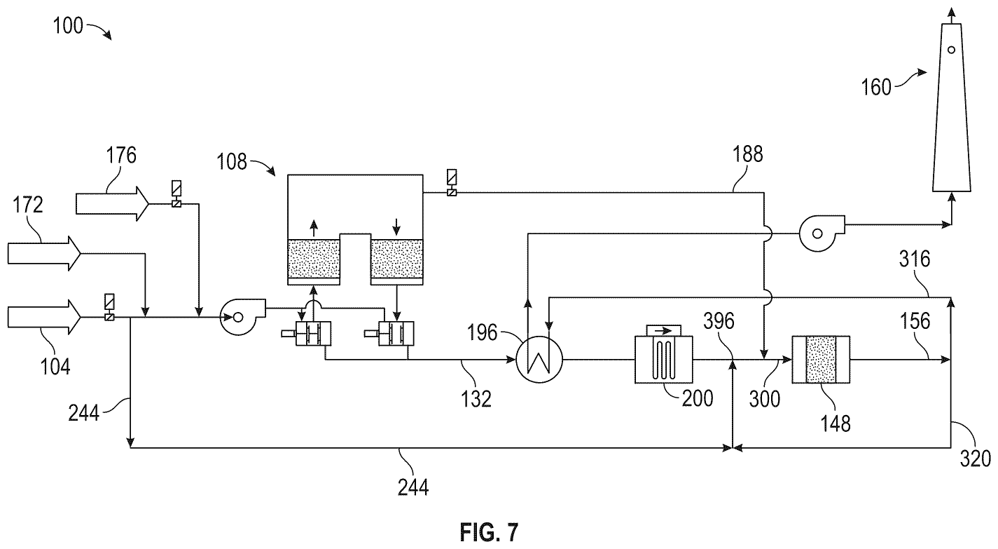

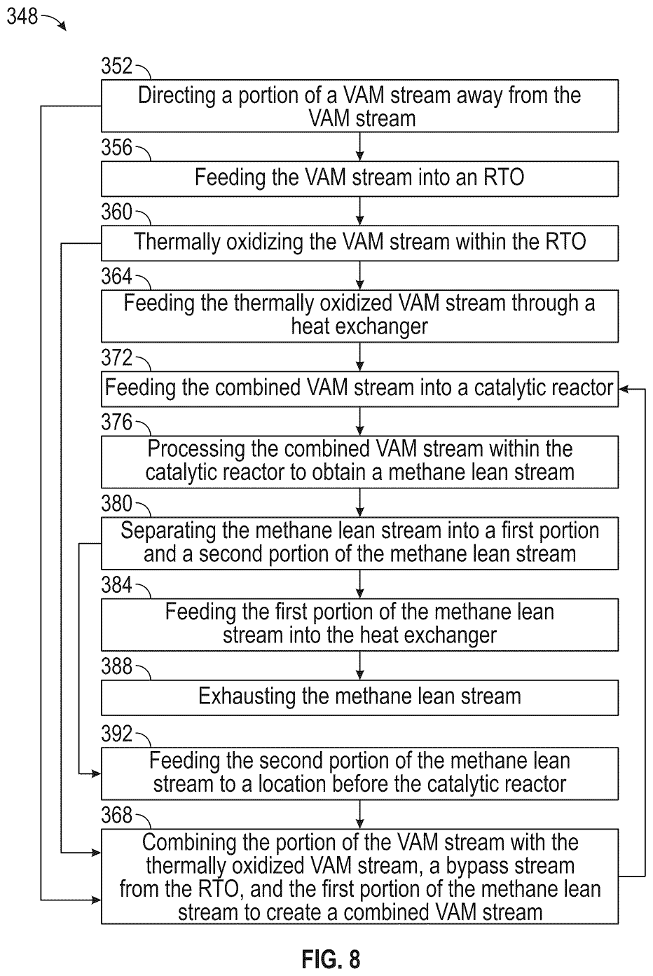

Turning now to FIG. 7 an embodiment of a VAM mitigation system 100 in accordance with the present disclosure is shown. FIG. 8 illustrates a process 348 related to the VAM mitigation system 100 of FIG. 7. To facilitate discussion of the VAM mitigation system 100, FIGS. 7 and 8 will be discussed below concurrently. It should be noted that the process 348 is not limiting, and the VAM mitigation system 100 and/or the process 348 may include additional or fewer steps than those illustrated, such as steps discussed above in any of the preceding figures. Further, the VAM mitigation system 100 and/or process 348 may include steps that are performed in an alternative order to that illustrated in process 348. That is, certain steps may be performed before, after, downstream, upstream, and/or concurrently to/with another respective step. The VAM mitigation system 100 illustrated in FIG. 7 may have similar elements and element numbering as that of the preceding figures. For example, at blocks 356 and 360, the VAM stream 104 from a mining operation may be directed towards and into the RTO 108 for methane oxidation or destruction in a generally similar manner to as described above with reference to block 106 of FIG. 2. In the illustrated embodiment, the VAM stream 104 may be supplemented with one or more process streams as described in detail above. For example, the VAM stream may be supplemented with a natural gas stream 172 and/or an airflow stream 176.

In the illustrated embodiment of the VAM mitigation system 100, at block 352, at least a portion of the VAM stream 104 (e.g., second VAM stream 244) is directed away from the VAM stream 104. In some embodiments, the second VAM stream 244 may not be directed through a catalytic reactor, an optional heater, and/or a heat exchanger. That is, at block 364, the thermally oxidized VAM stream 132 exiting the RTO 108 may be directed through the heat exchanger 196 to desirably increase the temperature of the thermally oxidized VAM stream 132, as discussed in detail above. At block 368, the second VAM stream 244 may be directed to be combined with the thermally oxidized VAM stream 132 without additional processing in of the second VAM stream 244, where the second VAM stream 244 and the thermally oxidized VAM stream 132 at least partially define a combined stream 300. In some embodiments, as discussed below, the combined stream 300 may include one or more of the bypass stream 188, the second VAM stream 244, the thermally oxidized VAM stream 132, and/or the second methane lean stream 320.

By adding the catalytic reactor 148 downstream of the RTO 108, relative to a flow of the thermally oxidized VAM stream 132, the second VAM stream 244 may bypass the RTO 108 without reducing efficiently (e.g., methane destruction efficiency) of the VAM mitigation system 100. For example, as will be appreciated, the second VAM stream 244 may include a higher methane percentage (e.g., weight percentage, volume percentage) than the thermally oxidized VAM stream 132 after processing within the RTO 108. Advantageously, the catalytic reactor 148 may be configured to receive the second VAM stream 144 to perform catalytic oxidization, destroying at least a portion of the methane within the second VAM stream 244 without thermal oxidization of the second VAM stream 244. Due to the bypass of the RTO 108 by the second VAM stream 244, the RTO 108 may experience a reduced VAM stream 104 mass flow rate. As such, the RTO 108 may operate at a reduced capacity, thereby increasing energy efficiency of the VAM mitigation system 100. Further, the size and/or quantity of the RTO(s) 108 of the VAM mitigation system 100 may be reduced due to the decreased mass flow rate, thereby decreases component costs.

At block 372 and 376, the combined stream 300 may be fed or directed into the catalytic reactor 148 for catalytic oxidation of the methane within the combined stream 300 in a generally similar manner as described above with reference to blocks 146 and 150 of FIG. 2.

At block 380, the methane lean stream 156 exiting the catalytic reactor 148 may be partitioned into a first methane lean stream 316 (e.g., first portion of the methane lean stream) and a second methane lean stream 320 (e.g., second portion of the methane lean stream) in a generally similar manner as discussed above with reference to blocks 232 and 258 of FIG. 6.

At block 384, the first methane lean stream 316 may be directed (e.g., recycled) to the heat exchanger 196 to be put in a heat exchange relationship with the upstream thermally oxidized VAM stream 132 as discussed above. In block 388, the first methane lean stream 316 (e.g., downstream of the heat exchanger 196) may be exhausted out of the VAM mitigation system 100 via any suitable means, such as, the exhaust stack 160

At block 392, the second methane lean stream 320 may be directed to an upstream location of the VAM mitigation system 100 to be combined (e.g., fluidly combined) with the thermally oxidized VAM stream 132, where the second methane lean stream 320 and the thermally oxidized VAM stream 132 at least partially define the combined stream 300 in block 368. For example, the second methane lean stream 320 may be directed to a location upstream of the catalytic reactor 148. As discussed above, the second methane lean stream 320 may include excess thermal energy, compared to the thermally oxidized VAM stream 132 and/or other components of the combined stream 300. By adding the second methane lean stream 320 to the thermally oxidized VAM stream 132 upstream of the catalytic reactor 148, the temperature of the combined stream 300 may be desirably increased towards a temperature that is equal to or greater than the threshold temperature utilized for catalytic oxidation of methane (e.g., light off temperature). In some embodiments, the addition of the second methane lean stream 320 to the thermally oxidized VAM stream 132 desirably increase the temperature of the combined stream 300 to a temperature that is equal to or greater than the threshold temperature, without using the optional heater 200. As such, in some embodiments, the VAM mitigation system 100 may not include the optional heater 200. Further, by recycling the second methane lean stream 320 to a location upstream the catalytic reactor 148, at least a portion of the methane lean stream 156 may undergo multiple passes through the catalytic reactor 148, increasing methane destruction and the overall efficiency of the VAM mitigation system 100.

Returning to block 368, the bypass stream 188 of the RTO 108 may be configured to combine with the thermally oxidized VAM stream 132 and/or the second VAM stream 244 upstream to the catalytic reactor 148, where the bypass stream 188, the thermally oxidized VAM stream 132, and/or the second VAM stream 244 may at least partially define the combined stream 300. In this way, the combined stream 300 may be heated to a temperature equal to or greater than the threshold temperature utilized for catalytic oxidation in the catalytic reactor 148. By directing the bypass stream 188 to increase the temperature of the combined stream 300, additional heat exchanging equipment may be reduced in size and/or may experience reduced energy consumption due to a lowered operating capacity. For example, in some embodiments, the bypass stream 188 may provide a sufficient amount of thermal energy to the combined stream 300 such that the optional heater 200 may be reduced in size or omitted from the VAM mitigation system 100 entirely, thereby reducing components costs. In some embodiments, the bypass stream 188 may be directed to a location downstream of the juncture 396 combining the thermally oxidized VAM stream 132 and the second VAM stream 244. In this way, the second VAM stream 244, may be desirably heated by the bypass stream 188 prior to entry into the catalytic reactor 142, thereby increasing the temperature of the second VAM stream 244 and/or the combined stream 300 to a temperature equal to or greater than the threshold temperature utilized for catalytic oxidization of methane.

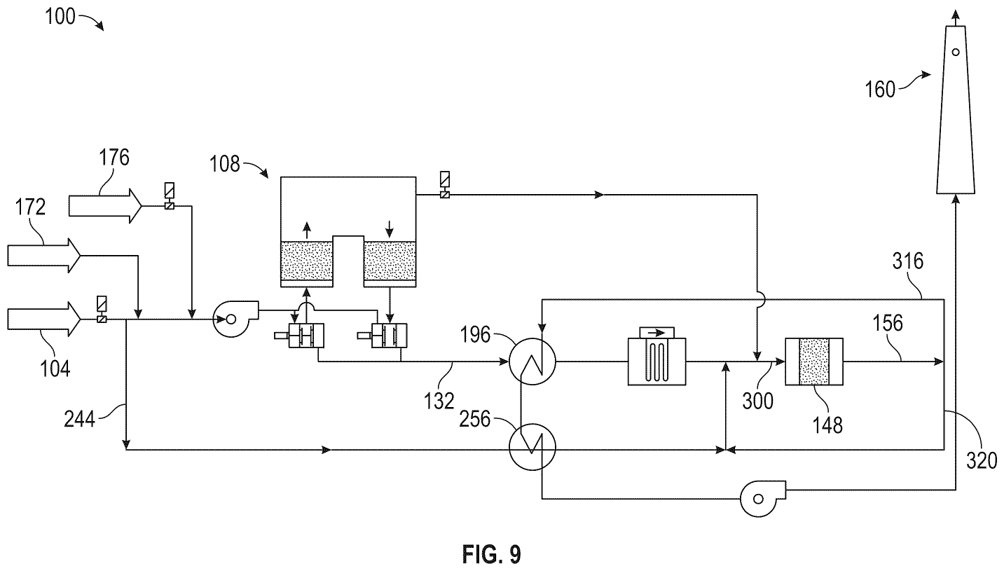

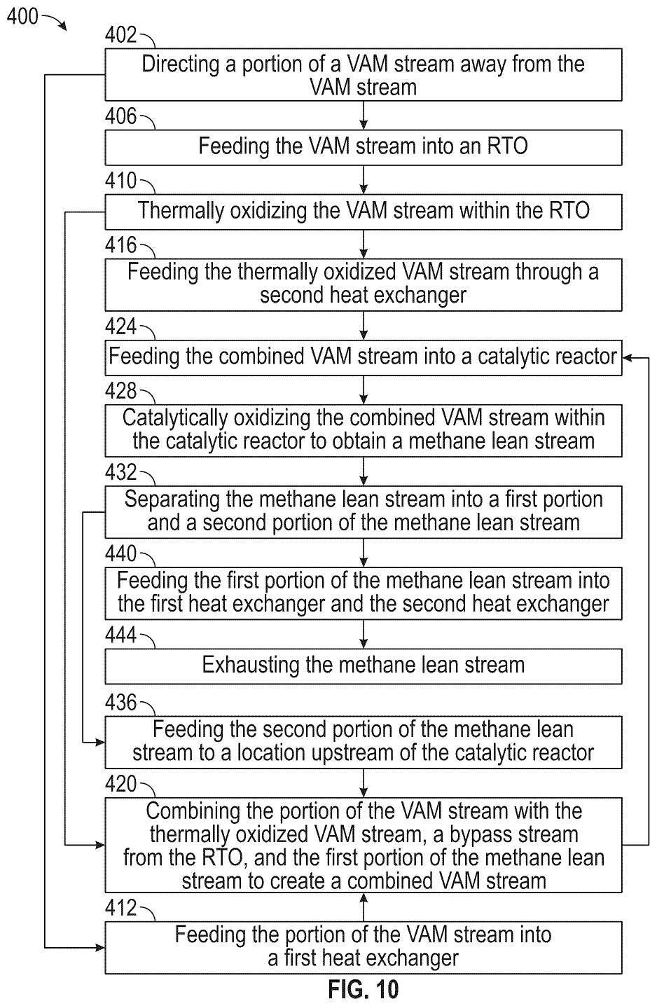

Referring now to FIG. 9, an embodiment of a VAM mitigation system 100 in accordance with the present disclosure is shown. FIG. 10 illustrates a process 400 related to the VAM mitigation system 100 of FIG. 9. To facilitate discussion of the VAM mitigation system 100, FIGS. 9 and 10 will be discussed below concurrently. It should be noted that the process 400 is not limiting, and the VAM mitigation system 100 and/or the process 400 may include more or less steps than those illustrated, such as steps discussed above in any of the preceding figures. Further, the VAM mitigation system 100 and/or process 400 may include steps that are performed in an alternative order to that illustrated in process 400. That is, certain steps may be performed before, after, or concurrently with another respective step. The VAM mitigation system 100 illustrated in FIG. 9 may have similar elements and element numbering as that of the preceding figures. For example, at blocks 406 and 410, the VAM stream 104 from a mining operation may be directed towards and into the RTO 108 for methane oxidation or destruction in a generally similar manner as described above with reference to block 106 of FIG. 2. In the illustrated embodiment, the VAM stream 104 may be supplemented with one or more process streams as described in detail above. For example, the VAM stream may be supplemented with a natural gas stream 172 and/or an airflow stream 176.

At block 402, at least a portion of the VAM stream 104 (e.g., second VAM stream 244) may be directed away from the VAM stream 104 in a generally similar manner as described above with reference to block 106 FIG. 1.

At block 412, the second VAM stream 244 may be directed into a heat exchanger 256 (e.g., first heat exchanger). That is, the heat exchanger 256 may be configured to place the second VAM stream 244 (e.g., first stream) into a heat exchange relationship with a second stream such that the second stream may transfer at least a portion of its thermal energy to the second VAM stream 244. In some embodiments, the second stream may be a stream recycled from a downstream location of the VAM mitigation system 100 similar to the heat exchanger 196 discussed above. By utilizing a recycled heated stream from a downstream location, the VAM mitigation system 100 may experience reduced energy consumption as a result of increasing the temperature of the second VAM stream 244 to a temperature equal to or greater than the threshold temperature utilized for catalytic oxidization in the catalytic reactor 148.

At block 416, the thermally oxidized VAM stream 132 exiting the RTO 108 may be directed through the heat exchanger 196 (e.g., second heat exchanger) to desirably increase the temperature of the thermally oxidized VAM stream 132, as discussed in detail above. At block 420, the second VAM stream 244 may be directed to be combined with the thermally oxidized VAM stream 132, where the second VAM stream 244 and the thermally oxidized VAM stream 132 at least partially define the combined stream 300. In some embodiments, as discussed below, the combined stream 300 may include one or more of the bypass streams 188, the second VAM stream 244, the thermally oxidized VAM stream 132 and/or the second methane lean stream 320.

At block 424 and 428, the combined stream 300 may be fed or directed into the catalytic reactor 148 for catalytic oxidation of the methane within the combined stream 300 in a matter similar to that described above.

At block 432, the methane lean stream 156 exiting the catalytic reactor 148 may be partitioned into a first methane lean stream 316 (e.g., first portion of the methane lean stream) and a second methane lean stream 320 (e.g., second portion of the methane lean stream) in a generally similar manner as discussed above with reference to blocks 232 and 258 of FIG. 6.

At block 436, the second methane lean stream 320 may be directed to an upstream location of the VAM mitigation system 100 to be combined with the thermally oxidized VAM stream 132, where the second methane lean stream 320 and the thermally oxidized VAM stream 132 at least partially define the combined stream 300 in block 420. Further, similar to the embodiment of the VAM mitigation system 100 in FIG. 7, the bypass stream 188 may be combined with the second VAM stream 244, the thermally oxidized VAM stream 132, and/or the second methane lean stream 320 to at least partially define the combined stream 300. In some embodiments, additional process streams may be added to the combined stream 300 upstream of the catalytic reactor 148.

At block 440, the first methane lean stream 316 may be directed (e.g., recycled) to the heat exchanger 196 (e.g., second heat exchanger) to be put in a heat exchange relationship with the upstream thermally oxidized VAM stream 132 as discussed above. Further, the either upstream or downstream of the heat exchanger 196, the first methane lean stream 316 may also be directed to the heat exchanger 256 (e.g., first heat exchanger) to put be put in a heat exchange relationship with the second VAM stream 244. As will be appreciated, the thermally oxidized VAM stream 132 may include a temperature greater than the temperature of the second VAM stream 244 due to thermal oxidation in the RTO 108. As such, after heat transfer from the first methane lean stream 316 to the thermally oxidized VAM stream 132, the first methane lean stream 316 may still include a temperature greater than the temperature of the second VAM stream 244. Therefore, by directing the first methane lean stream 316 into a heat exchange relationship with the second VAM stream 244 in the manner described above (e.g., after the heat exchanger 196), the first methane lean stream 316 may transfer excess thermal energy to the second VAM stream 244. In this way, the temperature of the second VAM stream 244 may desirably increase towards a temperature equal to or greater than the threshold temperature utilized for thermal oxidation of methane. The addition of a two or more heat exchangers (e.g., heat exchanger 196, heat exchanger 256) configured to transfer heat from the methane lean stream 156 to an upstream location (e.g., second VAM stream 244, thermally oxidized VAM stream 132) enables increased efficiency of the VAM mitigation system 100 due in part to the decease in additional heating sources.

At block 444, the first methane lean stream 316 may be exhausted out of the VAM mitigation system 100 via the exhaust stack 160.

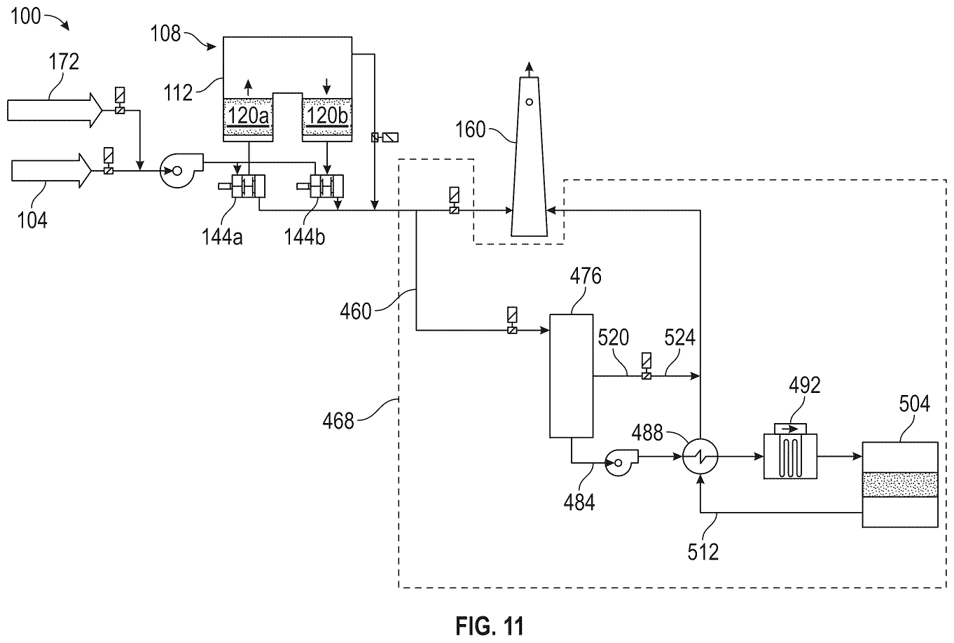

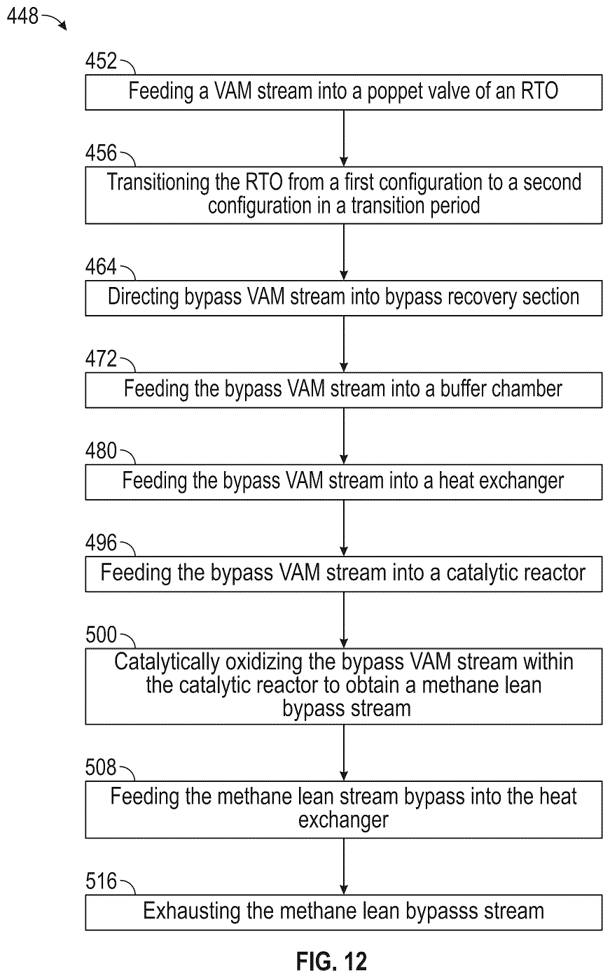

Referring now to FIG. 11, an embodiment of a VAM mitigation system 100 in accordance with the present disclosure is shown. FIG. 12 illustrates a process 448 related to the VAM mitigation system 100 of FIG. 11. To facilitate discussion of the VAM mitigation system 100, FIGS. 11 and 12 will be discussed below concurrently. It should be noted that the process 448 is not limiting, and the VAM mitigation system 100 and/or the process 448 may include additional or fewer steps than those illustrated, such as steps discussed above in any of the preceding figures. Further, the VAM mitigation system 100 and/or process 448 may include steps that are performed in an alternative order to that illustrated in process 448. That is, certain steps may be performed before, after, upstream, downstream and/or concurrently with/to another respective step. The VAM mitigation system 100 illustrated in FIG. 11 may have similar elements and element numbering as that of the preceding figures. At blocks 452, the VAM stream 104 from a mining operation may be directed towards and into the one or more airflow switching valves 144a, 144b of the RTO 108. In the illustrated embodiment, the VAM stream 104 may be supplemented with one or more process streams as described in detail above. For example, the VAM stream 104 may be supplemented with a natural gas stream 172 and/or an airflow stream.

At block 456, the RTO 108 may be configured to transition (e.g., reverse) from a first configuration to a second configuration or vice versa in order to increase energy efficiency. That is, thermal energy inherent in one heat exchanging media 120a, 120b (e.g., absorbed from the thermally oxidized VAM stream 132) may be used to heat the incoming VAM stream 104. As such, the RTO 108 may include one or more airflow switching valves 144a, 144b, (e.g., poppet valves) configured to reverse the flow of the VAM stream 104, reversing the flow of the thermally oxidized VAM stream 132. For example, the VAM stream 104 may be directed into a first airflow switching valve 144a and/or the second airflow switching valve 144b before being directed into the RTO 108 via the first port 124 or the second port 128. During a transition period, the first and second airflow switching valves 144a, 144b may “switch,” altering the flow of the VAM stream 104 into the RTO 108, changing the RTO 108 from the first configuration to the second configuration or vice versa. During the transition period, at least a portion of the VAM stream 104 (e.g., bypass VAM stream 460, bypass VAM stream 154, bypass stream, puff) entering the airflow switching valves 144a, 144b may bypass the RTO 108 (e.g., the fired burner 112), thereby bypassing thermal oxidation within the VAM mitigation system 100. As such, at block 464, the bypass VAM stream 460 may be directed into a bypass recovery section 468. It should be noted that the bypass recovery section 468 may also be used in regular operation (e.g., not during the transition period) of the RTO 108.

At block 472, the bypass VAM stream 460 may be directed into a buffer chamber 476 (e.g., puff chamber, compensation chamber, purge chamber) configured to destroy methane within the bypass VAM stream 460. For example, the buffer chamber 476 may be configured to use heat to thermally oxidize the methane within the bypass VAM stream 460 such that at least a portion of the methane is destroyed. Specifically, the buffer chamber 476 may include a flameless burner, a direct flame incinerator, or another suitable component for methane destruction. In some embodiments, the bypass recovery section 468 may not include a buffer chamber 476 and may rely entirely on the catalytic reactor 504 for methane destruction, reducing energy consumption.

In any case, at block 480, a processed bypass VAM stream 484 exiting the buffer chamber 476 may be directed through a heat exchanger 488 configured to increase the temperature of the processed bypass VAM stream 484 to a temperature equal to or greater than the threshold temperature utilized for catalytic oxidation of methane. That is, the heat exchanger 488 may be configured to place the processed bypass VAM stream 484 (e.g., first stream) into a heat exchange relationship with a second stream such that the second stream may transfer at least a portion of its thermal energy to the processed bypass VAM stream 484. In some embodiments, the second stream may be a stream recycled from a downstream location of the VAM mitigation system 100. By utilizing a recycled stream from a downstream location, the VAM mitigation system 100 may experience reduced energy consumption as additional heating components, such as optional heater 492, may operate at a reduced capacity or may be omitted from the VAM mitigation system 100 entirely.

At block 496 and 500, the processed bypass VAM stream 484 may be directed into a catalytic reactor 504 (e.g., third catalytic reactor) for catalytic oxidation of the methane within the processed bypass VAM stream 484. The catalytic reactor 504 may include a fixed bed catalyst, similar to the catalytic reactors discussed above, configured to enable continuous flow of the processed bypass VAM stream 484 through the catalytic reactor 504. Further, the catalytic reactor 504 may include the catalyst 152, where the catalyst may be a methane catalyst and may be supported by one or more materials, such as a zeolite and/or alumina. As will be appreciated, due to the limited time of the transition period (e.g., seconds, minutes), the bypass VAM stream 460 may include a reduced mass flow rate (e.g., reduced compared to the VAM stream 104). As such, the catalytic reactor 504 may include a reduced size (e.g., volume) compared to the catalytic reactor 148. By adding a catalytic reactor 504 to process the bypass VAM stream 460, the VAM mitigation system 100 may experience increased efficiency in methane destruction.

At block 508, a methane lean bypass stream 512 may be directed (e.g., recycled) to the heat exchanger 488 to be put in a heat exchange relationship with the processed bypass VAM stream 484. As will be appreciated, catalytic oxidization of methane within the catalytic reactor 504 may produce excess thermal energy as a byproduct of the reaction. As such, the methane lean bypass stream 512 exiting the catalytic reactor 504 may include excess thermal energy, compared to the processed bypass VAM stream 484 entering the catalytic reactor 504. By directing the methane lean bypass stream 512 into the heat exchanger 488 and into a heat exchange relationship with the processed bypass VAM stream 484, the methane lean bypass stream 512 may transfer at least a portion of its thermal energy to the processed bypass VAM stream 484. As such, the temperature of the processed bypass VAM stream 484 may desirably increase towards a temperature that is equal to or greater than the threshold temperature utilized for catalytic oxidation of methane. Therefore, the additional heating components, (e.g., the optional heater 492) may suspend operation or operate at a reduced capacity, thereby reducing energy consumption and increasing the efficiency of the VAM mitigation system 100.

At block 516, the methane lean bypass stream 512 may be directed out of the VAM mitigation system 100, such as through exhaust stack 160, and into the atmosphere or additional processing systems.

In some embodiments, the buffer chamber 476 may include buffer bypass conduit 520 configured to direct a buffer bypass stream 524 to be exhausted from the VAM mitigation system 100. For example, the buffer bypass conduit 520 may be configured to direct (e.g., bypass) the buffer bypass stream 524 to a location downstream of one or more components of the bypass recovery section 468, such as the heat exchanger 488, optional heater 492, and/or catalytic reactor 504. By bypassing certain components of the bypass recovery section 468, the components may suspend operation or may operate at a reduced capacity, reducing energy consumption of the VAM mitigation system 100. For example, after a determination, via one or more controllers of the VAM mitigation system 100, that the methane concentration (e.g., weight percentage, volume percentage, molecular percentage) is below a threshold (e.g., below 1%, 0.5%, 0.1%, etc.) after or during processing within the buffer chamber 476, the buffer bypass stream 524 may be directed out of the buffer bypass conduit 520 to be directed out of the VAM mitigation system 100.

As will be appreciated, the bypass recovery section 468 may be used in the VAM mitigation system alternate to or in addition to any component discussed herein. For example, in some embodiments, the bypass recovery section 468 may be used in addition to the secondary oxidation section 248 illustrated in FIG. 5.

As discussed herein, embodiments of the present disclosure are related to the utilization of methane specific catalysts in one or more catalytic reactors to destroy methane after processing within an RTO. For example, after thermal oxidation within one or more RTOs, a VAM stream may be directed through one or more catalytic reactors to destroy at least a portion of the remaining methane. Further, in accordance with present techniques, the flow of the VAM stream through the VAM mitigation system may be directed into one or more heat exchange relationships with prior streams (e.g., an upstream location of the VAM stream) to increase overall energy efficiency. For example, after thermal oxidization in the RTO and/or catalytic oxidation within the catalytic reactor, the VAM stream may include a high amount of thermal energy. As such, one or more recycle streams of the VAM stream containing a high amount of thermal energy may be used to increase the temperature of the upstream VAM stream entering the catalytic reactor to increase the temperature of the VAM stream to a temperature equal to or greater than the threshold temperature utilized for catalytic oxidation of methane, without or with reduced additional thermal energy sources. Furthermore, the use of downstream (e.g., relative to the RTO) catalytic reactors enables reduced size and/or quantity of RTO(s) by enabling partitioning or redirection of at least a portion of the VAM stream away from the RTO. For example, the RTO may experience reduced mass flow rates of the VAM stream due to the redirection of the portion of the VAM stream, enabling a reduced size of the RTO, a reduced quantity of RTOs, and/or a reduced operating capacity of the RTO. The present disclosure further relates to efficiently destroying methane within a bypass VAM stream created during a transition period of the RTO.

Having described various systems, methods, and processes, certain embodiments can include, but are not limited to:

In an embodiment, a process for air purification includes feeding a first stream including methane into a regenerative thermal oxidizer (RTO), where the RTO may thermally oxidize a first portion of the methane within the first stream. The process also includes obtaining a thermally oxidized first stream from the RTO, where the thermally oxidized first stream includes a second portion of the methane, and the second portion of the methane is not thermally oxidized within the RTO. The process further includes feeding the thermally oxidized first stream into a catalytic reactor that may catalytically oxidize the second portion of methane within the thermally oxidized first stream, where the catalytic reactor includes a methane catalyst, and obtaining a methane lean stream from the catalytic reactor.

In another embodiment, a system for air purification includes an RTO that may to thermally oxidize a first portion of methane within a first stream to create a thermally oxidized first stream. The system further includes a catalytic reactor that may catalytically oxidize a second portion of the methane within the first stream to create a methane lean stream, where the catalytic reactor includes a methane catalyst.

In another embodiment, a process for air purification includes feeding a first stream including methane into an RTO, where the RTO may thermally oxidize a first portion of the methane within the first stream and obtaining a thermally oxidized first stream from the RTO, where the thermally oxidized first stream includes a second portion of the methane, and the second portion of the methane is not thermally oxidized within the RTO. The process further includes feeding the thermally oxidized first stream into a heat exchanger that may place the thermally oxidized first stream into a heat exchange relationship with a methane lean stream and feeding the thermally oxidized first stream into a catalytic reactor that may catalytically oxidize the second portion of methane within the first stream, where the catalytic reactor includes a methane catalyst. The process also includes obtaining a methane lean stream from the catalytic reactor and recycling the methane lean stream into the heat exchanger.

In another embodiment, a system for air purification includes an RTO that may thermally oxidize a first portion of methane within a first stream to create a thermally oxidized first stream and a catalytic reactor that may catalytically oxidize a second portion of the methane within the first stream to create a methane lean stream, where the catalytic reactor includes a methane catalyst. The system further includes a heat exchanger that may put the thermally oxidized first stream into a heat exchange relationship with the methane lean stream.

In another embodiment, a process for air purification includes directing a portion of a first stream into a first heat exchanger, where the portion of the first stream is a second stream and the first heat exchanger may place the second stream in a heat exchange relationship with a second portion of a methane lean stream. The process also includes feeding the second stream into a first catalytic reactor that may catalytically oxidize a first portion of methane within the second stream, where the first catalytic reactor includes a methane catalyst and obtaining a catalytically oxidized second stream from the first catalytic reactor, where the catalytically oxidized second stream includes a second portion of methane within the second stream, and the second portion of methane within the second stream is not catalytically oxidized within the first catalytic reactor. The process further includes feeding the first stream into an RTO, where the RTO may thermally oxidize a first portion of the methane within the first stream and obtaining a thermally oxidized first stream from the RTO, where the thermally oxidized first stream includes a second portion of methane within the first stream, and the second portion of methane within the first stream is not thermally oxidized. The process further includes feeding the thermally oxidized first stream into a second heat exchanger that may place the thermally oxidized first stream into a heat exchange relationship with a first portion of the methane lean stream and combining the thermally oxidized first stream with the catalytically oxidized second stream upstream of a second catalytic reactor, relative to a flow of the thermally oxidized first stream, where the thermally oxidized first stream and the catalytically oxidized second stream at least partially define a combined stream. The process further includes feeding the combined stream into the second catalytic reactor that may catalytically oxidize the second portion of methane within the first stream and the second portion of methane within the second stream, where the second catalytic reactor includes a methane catalyst and obtaining the methane lean stream from the second catalytic reactor. The process further includes partitioning the methane lean stream into the first portion of the methane lean stream and the second portion of the methane lean stream, recycling the first portion of the methane lean stream into the second heat exchanger, and recycling the second portion of the methane lean stream into the first heat exchanger.

In another embodiment, a system for air purification includes an RTO that may thermally oxidize a first portion of methane within a first stream to create a thermally oxidized first stream, where the thermally oxidized first stream includes a second portion of the methane within the first stream, and the second portion of the methane within the first stream is not thermally oxidized. The system also includes a first catalytic reactor including a methane catalyst, the first catalytic reactor may catalytically oxidize a first portion of the methane within a second stream to create a catalytically oxidized second stream, where the second stream is a portion of the first stream, where the catalytically oxidized second stream includes a second portion of the methane within the second stream, and the second portion of the methane within the second stream is not catalytically oxidized in the first catalytic reactor. The system further includes a second catalytic reactor including the methane catalyst, the second catalytic reactor may catalytically oxidize methane within a combined stream to create a methane lean stream, where the catalytically oxidized second stream and the thermally oxidized first stream at least partially define the combined stream. The system also includes a first heat exchanger may put the second stream into a heat exchange relationship with a second portion of the methane lean stream and a second heat exchanger that may put the thermally oxidized first stream in a heat exchange relationship with a first portion of the methane lean stream.

In another embodiment, a process for air purification includes directing a second stream away from a first stream including methane, where the second stream is a portion of the first stream and feeding the first stream into an RTO, where the RTO may thermally oxidize a first portion of the methane within the first stream. The process also includes obtaining a thermally oxidized first stream from the RTO, where the thermally oxidized first stream includes a second portion of methane within the first stream, and the second portion of methane within the first stream is not thermally oxidized and feeding the thermally oxidized first stream into a heat exchanger that may place the thermally oxidized first stream into a heat exchange relationship with a first methane lean stream and combining the thermally oxidized first stream with the second stream upstream of a catalytic reactor, relative to a flow of the thermally oxidized first stream, where the thermally oxidized first stream and the second stream at least partially define a combined stream. The process further includes feeding the combined stream into the catalytic reactor that may catalytically oxidize the second portion of methane within the first stream and methane within the second stream, where the catalytic reactor includes a methane catalyst and obtaining a methane lean stream from the catalytic reactor. The process further includes partitioning the methane lean stream into a first methane lean stream and a second methane lean stream, recycling the first methane lean stream into the heat exchanger, and combining the second methane lean stream with the combined stream.

In another embodiment, a system for air purification includes an RTO that may thermally oxidize methane within a first stream to create a thermally oxidized first stream and a catalytic reactor including a methane catalyst, the catalytic reactor may catalytically oxidize methane within a combined stream to create a methane lean stream, where the combined stream includes a second stream; where the second stream is a portion of the first stream and where the second stream may bypass thermal oxidation within the RTO. The combined stream further includes the thermally oxidized first stream and a second portion of the methane lean stream. The system further includes a heat exchanger that may place the thermally oxidized first stream in a heat exchange relationship with a first portion of the methane lean stream.

In another embodiment, a process for air purification includes directing a second stream into a first heat exchanger, where the second stream is a portion of a first stream and the first heat exchanger may place the second stream into a heat exchange relationship with a first portion of a methane lean stream, where the first stream includes methane and feeding the first stream into an RTO, where the RTO may thermally oxidize a first portion of the methane within the first stream. The process further includes obtaining a thermally oxidized first stream from the RTO, where the thermally oxidized first stream includes a second portion of methane within the first stream, and the second portion of methane within the first stream is not thermally oxidized and feeding the thermally oxidized first stream into a second heat exchanger that may place the thermally oxidized first stream into a heat exchange relationship with the first portion of the methane lean stream. The process further includes combining the thermally oxidized first stream with the second stream upstream of a catalytic reactor, relative to a flow of the thermally oxidized first stream, where the thermally oxidized first stream and the second stream at least partially define a combined stream and feeding the combined stream into the catalytic reactor that may catalytically oxidize methane within the combined stream, where the catalytic reactor includes a methane catalyst. The process further includes obtaining a methane lean stream from the catalytic reactor, partitioning the methane lean stream into a first portion of the methane lean stream and a second portion of the methane lean stream, recycling the first portion of the methane lean stream into the first heat exchanger and the second heat exchanger, and combining the second portion of the methane lean stream with the combined stream.

In another embodiment, a system for air purification includes an RTO that may thermally oxidize methane within a first stream to create a thermally oxidized first stream and a catalytic reactor including a methane catalyst, the catalytic reactor may catalytically oxidize methane within a combined stream to create a methane lean stream. The combined stream may include a second stream, where the second stream is a portion of the first stream and where the second stream may bypass thermal oxidation within the RTO, the thermally oxidized first stream, and a second portion of the methane lean stream. The system further includes a first heat exchanger that may place the second stream in a heat exchange relationship with a first portion of the methane lean stream and a second heat exchanger that may put the thermally oxidized first stream in a heat exchange relationship with the first portion of the methane lean stream.

In another embodiment, a process for air purification includes feeding a first stream including methane into an RTO that may transition between a first configuration and a second configuration, where the RTO comprises one or more airflow switching valves that may receive the first stream. The process further includes transitioning the RTO from the first configuration to the second configuration during a transition period and obtaining a bypass stream from the RTO during the transition period, where the bypass stream is not thermally oxidized within the RTO and directing the bypass stream into a heat exchanger that may place the bypass stream in a heat exchange relationship with a methane lean stream. The process further includes feeding the bypass stream into a catalytic reactor that may catalytically oxidize the methane to create the methane lean stream, where the catalytic reactor comprises a methane catalyst, and directing the methane lean stream into the heat exchanger.

In a further embodiment, a system for air purification includes an RTO that may transition between a first configuration and a second configuration in a transition period, where the RTO may output a bypass stream in the transition period, and the bypass stream comprising methane. The system also includes a catalytic reactor including a methane catalyst, the catalytic reactor may catalytically oxidize methane within the bypass stream to create a methane lean stream; and a heat exchanger that may place the bypass stream in a heat exchange relationship with the methane lean stream.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Each and every claim is incorporated into the specification as an aspect of the present disclosure. Thus, the claims are a further description and are an addition to the aspects of the present disclosure. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A process for air purification, the process comprising:
feeding a first stream comprising methane into a regenerative thermal oxidizer (RTO), wherein the RTO is configured to thermally oxidize a first portion of the methane within the first stream;
obtaining a thermally oxidized first stream from the RTO, wherein the thermally oxidized first stream comprises a second portion of the methane, and the second portion of the methane is not thermally oxidized within the RTO;
feeding the thermally oxidized first stream into a catalytic reactor configured to catalytically oxidize the second portion of methane within the thermally oxidized first stream, wherein the catalytic reactor comprises a methane catalyst; and
obtaining a methane lean stream from the catalytic reactor.

2. The process of claim 1, wherein the first stream comprises a volume percentage of methane in the range of 0.1% and 2%.

3. The process of claim 1, the process further comprising:
feeding the thermally oxidized first stream into a heat exchanger configured to place the thermally oxidized first stream into a heat exchange relationship with the methane lean stream; and
recycling the methane lean stream into the heat exchanger.

4. The process of claim 3, wherein the first stream comprises a natural gas stream, an airflow stream, or both.

5. The process of claim 3, further comprising:
bypassing a portion of the first stream from the RTO through a bypass conduit extending from a fired burner of the RTO, wherein the portion of the first stream is a bypass stream; and
combining the bypass stream with the thermally oxidized first stream downstream of the RTO, relative to a flow of the first stream.

6. The process of claim 1, the process further comprising:
directing a second stream away from the first stream comprising methane, wherein the second stream is a portion of the first stream;
feeding the first stream into the RTO, wherein the RTO is configured to thermally oxidize a first portion of the methane within the first stream;
obtaining the thermally oxidized first stream from the RTO, wherein the thermally oxidized first stream comprises a second portion of methane within the first stream, and the second portion of methane within the first stream is not thermally oxidized;
feeding the thermally oxidized first stream into a heat exchanger configured to place the thermally oxidized first stream into a heat exchange relationship with a first methane lean stream;
combining the thermally oxidized first stream with the second stream upstream of the catalytic reactor, relative to a flow of the thermally oxidized first stream, wherein the thermally oxidized first stream and the second stream at least partially define a combined stream;
feeding the combined stream into the catalytic reactor configured to catalytically oxidize the second portion of methane within the first stream and methane within the second stream, wherein the catalytic reactor comprises the methane catalyst;
obtaining the methane lean stream from the catalytic reactor;
partitioning the methane lean stream into a first methane lean stream and a second methane lean stream;
recycling the first methane lean stream into the heat exchanger; and
combining the second methane lean stream with the combined stream.

7. The process of claim 6, further comprising:
bypassing a second portion of the first stream from the RTO through a bypass conduit extending from a fired burner of the RTO, wherein the second portion of the first stream is a bypass stream; and
combining the bypass stream with the combined stream upstream of the catalytic reactor, relative to the flow of the thermally oxidized first stream.

8. The process of claim 1, the process further comprising:
directing a second stream into a first heat exchanger, wherein the second stream is a portion of a first stream and the first heat exchanger is configured to place the second stream into a heat exchange relationship with a first portion of the methane lean stream, wherein the first stream comprises methane;
feeding the first stream into the RTO, wherein the RTO is configured to thermally oxidize a first portion of the methane within the first stream;
obtaining the thermally oxidized first stream from the RTO, wherein the thermally oxidized first stream comprises a second portion of methane within the first stream, and the second portion of methane within the first stream is not thermally oxidized;
feeding the thermally oxidized first stream into a second heat exchanger configured to place the thermally oxidized first stream into a heat exchange relationship with the first portion of the methane lean stream;
combining the thermally oxidized first stream with the second stream upstream of the catalytic reactor, relative to a flow of the thermally oxidized first stream, wherein the thermally oxidized first stream and the second stream at least partially define a combined stream;
feeding the combined stream into the catalytic reactor configured to catalytically oxidize methane within the combined stream, wherein the catalytic reactor comprises the methane catalyst;
obtaining a methane lean stream from the catalytic reactor;
partitioning the methane lean stream into a first portion of the methane lean stream and a second portion of the methane lean stream;
recycling the first portion of the methane lean stream into the first heat exchanger and the second heat exchanger; and
combining the second portion of the methane lean stream with the combined stream.

9. The process of claim 8, comprising:
bypassing a second portion of the first stream from the RTO through a bypass conduit extending from a fired burner of the RTO, wherein the second portion of the first stream is a bypass stream; and
combining the bypass stream with the combined stream upstream of the catalytic reactor, relative to a flow of the thermally oxidized first stream.

10. The process of claim 1, the process further comprising:
feeding a first stream comprising methane into the RTO configured to transition between a first configuration and a second configuration, wherein the RTO comprises one or more airflow switching valves configured to receive the first stream;
transitioning the RTO from the first configuration to the second configuration during a transition period;
obtaining a bypass stream from the RTO during the transition period, wherein the bypass stream is not thermally oxidized within the RTO;
directing the bypass stream into a heat exchanger configured to place the bypass stream in a heat exchange relationship with the methane lean stream;
feeding the bypass stream into the catalytic reactor configured to catalytically oxidize the methane to create the methane lean stream, wherein the catalytic reactor comprises the methane catalyst; and
directing the methane lean stream into the heat exchanger.

11. A process for air purification, the process comprising:
directing a portion of a first stream into a first heat exchanger, wherein the portion of the first stream is a second stream and the first heat exchanger is configured to place the second stream in a heat exchange relationship with a second portion of a methane lean stream;
feeding the second stream into a first catalytic reactor configured to catalytically oxidize a first portion of methane within the second stream, wherein the first catalytic reactor comprises a methane catalyst;
obtaining a catalytically oxidized second stream from the first catalytic reactor, wherein the catalytically oxidized second stream comprises a second portion of methane within the second stream, and the second portion of methane within the second stream is not catalytically oxidized within the first catalytic reactor;
feeding the first stream into a regenerative thermal oxidizer (RTO), wherein the RTO is configured to thermally oxidize a first portion of the methane within the first stream;
obtaining a thermally oxidized first stream from the RTO, wherein the thermally oxidized first stream comprises a second portion of methane within the first stream, and the second portion of methane within the first stream is not thermally oxidized;
feeding the thermally oxidized first stream into a second heat exchanger configured to place the thermally oxidized first stream into a heat exchange relationship with a first portion of the methane lean stream;
combining the thermally oxidized first stream with the catalytically oxidized second stream upstream of a second catalytic reactor, relative to a flow of the thermally oxidized first stream, wherein the thermally oxidized first stream and the catalytically oxidized second stream at least partially define a combined stream;
feeding the combined stream into the second catalytic reactor configured to catalytically oxidize the second portion of methane within the first stream and the second portion of methane within the second stream, wherein the second catalytic reactor comprises a methane catalyst;
obtaining the methane lean stream from the second catalytic reactor;
partitioning the methane lean stream into the first portion of the methane lean stream and the second portion of the methane lean stream;
recycling the first portion of the methane lean stream into the second heat exchanger; and
recycling the second portion of the methane lean stream into the first heat exchanger.

12. The process of claim 11, comprising:
bypassing a second portion of the first stream from the RTO through a bypass conduit extending from a fired burner of the RTO, wherein the second portion of the first stream is a bypass stream; and
combining the bypass stream with the second stream upstream of the first catalytic reactor, relative to a flow of the second stream.

13. A system for air purification, the system comprising:
a regenerative thermal oxidizer (RTO) configured to thermally oxidize a first portion of methane within a first stream to create a thermally oxidized first stream; and
a catalytic reactor configured to catalytically oxidize a second portion of the methane within the first stream to create a methane lean stream, wherein the catalytic reactor comprises a methane catalyst.

14. The system of claim 13, wherein the catalytic reactor is disposed downstream of the RTO relative to a flow of the first stream.

15. The system of claim 13, the system further comprising:
a heat exchanger configured to put the thermally oxidized first stream into a heat exchange relationship with the methane lean stream.

16. The system of claim 13, the system further comprising:
the RTO configured to thermally oxidize the first portion of methane within the first stream to create the thermally oxidized first stream, wherein the thermally oxidized first stream comprises a second portion of the methane within the first stream, and the second portion of the methane within the first stream is not thermally oxidized;
the catalytic reactor being a first catalytic reactor comprising the methane catalyst, the first catalytic reactor configured to catalytically oxidize a first portion of the methane within a second stream to create a catalytically oxidized second stream, wherein the second stream is a portion of the first stream, wherein the catalytically oxidized second stream comprises a second portion of the methane within the second stream, and the second portion of the methane within the second stream is not catalytically oxidized in the first catalytic reactor;
a second catalytic reactor comprising the methane catalyst, the second catalytic reactor configured to catalytically oxidize methane within a combined stream to create a methane lean stream, wherein the catalytically oxidized second stream and the thermally oxidized first stream at least partially define the combined stream;
a first heat exchanger configured to put the second stream into a heat exchange relationship with a second portion of the methane lean stream; and
a second heat exchanger configured to put the thermally oxidized first stream in a heat exchange relationship with a first portion of the methane lean stream.

17. The system of claim 16, wherein the second catalytic reactor is disposed downstream of the RTO relative to a flow of the thermally oxidized first stream.

18. The system of claim 13, the system further comprising:
the catalytic reactor configured to catalytically oxidize methane within a combined stream to create a methane lean stream, wherein the combined stream comprises:
a second stream; wherein the second stream is a portion of the first stream and wherein the second stream is configured to bypass thermal oxidation within the RTO;
the thermally oxidized first stream; and
a second portion of the methane lean stream; and
a heat exchanger configured to place the thermally oxidized first stream in a heat exchange relationship with a first portion of the methane lean stream.

19. The system of claim 18, wherein the catalytic reactor is disposed downstream of the RTO relative to a flow of the thermally oxidized first stream.

20. The system of claim 13, wherein the catalytic reactor configured to catalytically oxidize methane within a combined stream to create the methane lean stream, wherein the combined stream comprises:
a second stream, wherein the second stream is a portion of the first stream and wherein the second stream is configured to bypass thermal oxidation within the RTO;
the thermally oxidized first stream; and
a second portion of the methane lean stream;
a first heat exchanger configured to place the second stream in a heat exchange relationship with a first portion of the methane lean stream; and
a second heat exchanger configured to put the thermally oxidized first stream in a heat exchange relationship with the first portion of the methane lean stream.

21. The system of claim 20, wherein the catalytic reactor is disposed downstream of the RTO relative to a flow of the thermally oxidized first stream.

22. The system of claim 13, wherein the RTO configured to transition between a first configuration and a second configuration in a transition period, wherein the RTO is configured to output a bypass stream in the transition period, and the bypass stream comprising methane;
the catalytic reactor configured to catalytically oxidize methane within the bypass stream to create a methane lean stream; and
the system further comprising a heat exchanger configured to place the bypass stream in a heat exchange relationship with the methane lean stream.

23. The system of claim 22, wherein the catalytic reactor is disposed downstream of the RTO relative to a flow of the bypass stream.

24. The system of claim 22, further comprising a buffer chamber configured to thermally oxidize the methane within the bypass stream.
